(19) United States
(12) Patent Application Publication
(10) Pub. No.: US 2025/0247137 A1
(43) Pub. Date: Jul. 31, 2025

(54) CHANNEL STATE INFORMATION (CSI) REPORTING

(71) Applicant: Lenovo (Singapore) Pte. Limited, Singapore (SG)

(72) Inventors: Ahmed Hindy, Aurora, IL (US); Khaled Nafez Rauf Ardah, Ilmenau (DE)

(73) Assignee: Lenovo (Singapore) Pte. Limited, Singapore (SG)

(21) Appl. No.: 19/039,551

(22) Filed: Jan. 28, 2025

Related U.S. Application Data
(60) Provisional application No. 63/626,888, filed on Jan. 30, 2024.

(51) Int. Cl. H04B 7/06; H04B 7/0456; H04L 5/00; H04L 5/14; H04W 24/10

(52) U.S. Cl. CPC H04B 7/0626; H04B 7/0456; H04B 7/0632; H04L 5/0044; H04L 5/14; H04W 24/10

(57) ABSTRACT

Various aspects of the present disclosure relate to channel state information (CSI) reporting. An apparatus, such as a user equipment (UE), receives a configuration message for CSI reporting, the configuration message indicating one or more configuration parameter sets for different sets of slots in a bandwidth part (BWP); and transmits, based at least in part on the configuration message and the one or more configuration parameter sets, at least one CSI report indicating a first CSI report quantity including a first value for a first set of slots associated with sub-band full duplex (SBFD) symbols and a second value for a second set of slots associated with non-SBFD symbols corresponding to downlink (DL) transmission.

### RELATED APPLICATION

This application claims priority to U.S. Provisional Application Ser. No. 63/626,888 filed 30 Jan. 2024 entitled “CSI REPORTING ENHANCEMENTS,” the disclosure of which is incorporated by reference herein in its entirety.

### TECHNICAL FIELD

The present disclosure relates to wireless communications, and more specifically to sub-band full duplex (SBFD) communication.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive a configuration message for channel state information (CSI) reporting, the configuration message indicating one or more configuration parameter sets for different sets of slots in a bandwidth part (BWP); and transmit, based at least in part on the configuration message and the one or more configuration parameter sets, at least one CSI report indicating a first CSI report quantity including a first value for a first set of slots associated with sub-band full duplex (SBFD) symbols and a second value for a second set of slots associated with non-SBFD symbols corresponding to downlink (DL) transmission.

In some implementations of the method and apparatuses described herein, the first set of slots includes at least one sub-band group associated with uplink (UL) transmission and at least one other sub-band group associated with DL transmission. The at least one CSI report indicates a second CSI report quantity including a first value for the at least one sub-band group and a second value for the at least one other sub-band group. The second CSI report quantity corresponds to a channel quality indicator (CQI), the at least one CSI report indicating a first CQI value associated with the at least one sub-band group and a second CQI value associated with the at least one other sub-band group. The second CSI report quantity corresponds to a precoding matrix indicator (PMI), the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

In some implementations of the method and apparatuses described herein, the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common rank indicator (RI) value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Some implementations of the method and apparatuses described herein may further include a processor for wireless communication to receive a configuration message for CSI reporting, the configuration message indicating one or more configuration parameter sets for different sets of slots in a BWP; and transmit, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

In some implementations of the method and apparatuses described herein, the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

In some implementations of the method and apparatuses described herein, the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Some implementations of the method and apparatuses described herein may further include a method performed by a UE, the method including: receiving a configuration message for CSI reporting, the configuration message indicating one or more configuration parameter sets for different sets of slots in a BWP; and transmitting, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

In some implementations of the method and apparatuses described herein, the method further including the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

In some implementations of the method and apparatuses described herein, the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Some implementations of the method and apparatuses described herein may further include a NE for wireless communication to transmit a configuration message for CSI reporting, the configuration message indicating one or more configuration parameter sets for different sets of slots in a BWP; and receive, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

In some implementations of the method and apparatuses described herein, the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

In some implementations of the method and apparatuses described herein, the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Some implementations of the method and apparatuses described herein may further include a method performed by a NE, the method including: transmitting a configuration message for CSI reporting, the configuration message indicating one or more configuration parameter sets for different sets of slots in a BWP; and receiving, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

In some implementations of the method and apparatuses described herein, the method further including the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

In some implementations of the method and apparatuses described herein, the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Some implementations of the method and apparatuses described herein may further include a UE for wireless communication to receive a configuration message for CSI reference signal (CSI-RS) resource settings, the configuration message indicating one or more CSI-RS resources, where at least one CSI-RS resource is associated with two different time resource types; and transmit, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

In some implementations of the method and apparatuses described herein, the first CSI-RS resource setting includes a first frequency domain resource allocation (FDRA) physical-to-virtual mapping and the second CSI-RS resource setting includes a second FDRA physical-to-virtual mapping. The UE to apply the first FDRA physical-to-virtual mapping during the first time resource type and the second FDRA physical-to-virtual mapping during the second time resource type. Each of the one or more CSI-RS resources is associated with one or more time resource index sets. The UE to determine a FDRA mapping for a CSI-RS resource based on a physical-to-virtual resource blocks (RBs) mapping method indicated by the configuration message. A time resource type incudes a SBFD time resource type or a non-SBFD time resource type. The configuration message indicates one or more of the SBFD time resource type or the non-SBFD time resource type. The UE to receive another configuration message indicating one or more of the SBFD time resource type or the non-SBFD time resource type. A FDRA of a CSI-RS resource is indicated via at least one of: a start RB or a number of RBs.

In some implementations of the method and apparatuses described herein, the configuration message further indicates a physical-to-virtual RBs mapping configuration. The physical-to-virtual RBs mapping configuration indicates at least one of: a method index, a start RB, or a total number of RBs. The UE to determine at least one of the start RB or the total number of RBs based on at least one of: a BWP configuration message or a SBFD time-frequency resource configuration message. The UE to map a physical RBs group to a virtual RBs group based on the physical-to-virtual RBs mapping configuration. The configuration message indicates a grouping level for the mapping of the physical RBs group to the virtual RBs group. The UE to perform an RB-overlapping-handling scheme indicated by the configuration message in response to determining that one or more RBs of a CSI-RS resource overlap one or more RBs of a sub-band outside one or more DL sub-bands. The UE to exclude the one or more RBs overlapping the one or more RBs of a sub-band outside one or more DL sub-bands; or applying an offset to a start RB parameter of the CSI-RS resource. The one or more CSI-RS resources includes a first set of CSI-RS resources associated with the first time resource type or a first set of time resource indexes, and a second set of CSI-RS resources associated with the second time resource type or a second set of time resource indexes. The UE to determine a first FDRA physical-to-virtual mapping for a CSI-RS resource of the first set of CSI-RS resources or a first index of the first set of time resource indexes; and determine a second FDRA physical-to-virtual mapping for a CSI-RS resource of the second set of CSI-RS resources or a second index of the second set of time resource indexes. A CSI-RS resource associated with a time resource type or time resource index occupying two non-contiguous DL sub-bands (SBs) in a BWP is configured with two CSI resource frequency occupation parameter sets. A CSI resource frequency occupation parameter set includes a start RB location indicator and a number of RBs indicator. A first of the two CSI resource frequency occupation parameter sets is indicated by an offset RBs to the second of the two CSI resource frequency occupation parameter sets. A first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

Some implementations of the method and apparatuses described herein may further include a processor for wireless communication to receive a configuration message for CSI-RS resource settings, the configuration message indicating one or more CSI-RS resources, where at least one CSI-RS resource is associated with two different time resource types; and transmit, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Some implementations of the method and apparatuses described herein may further include a method performed by a UE, the method including: receiving a configuration message for CSI-RS resource settings, the configuration message indicating one or more CSI-RS resources, where at least one CSI-RS resource is associated with two different time resource types; and transmitting, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

In some implementations of the method and apparatuses described herein, the method further including determining a FDRA mapping for a CSI-RS resource based on a physical-to-virtual RBs mapping method indicated by the configuration message; receiving another configuration message indicating one or more of the SBFD time resource type or the non-SBFD time resource type; determining at least one of the start RB or the total number of RBs based on at least one of: a BWP configuration message or a SBFD time-frequency resource configuration message; mapping a physical RBs group to a virtual RBs group based on the physical-to-virtual RBs mapping configuration; performing an RB-overlapping-handling scheme indicated by the configuration message in response to determining that one or more RBs of a CSI-RS resource overlap one or more RBs of a sub-band outside one or more DL sub-bands; excluding the one or more RBs overlapping the one or more RBs of a sub-band outside one or more DL sub-bands; or applying an offset to a start RB parameter of the CSI-RS resource. The method further including determining a first FDRA physical-to-virtual mapping for a CSI-RS resource of the first set of CSI-RS resources or a first index of the first set of time resource indexes; determining a second FDRA physical-to-virtual mapping for a CSI-RS resource of the second set of CSI-RS resources or a second index of the second set of time resource indexes.

Some implementations of the method and apparatuses described herein may further include a NE for wireless communication to transmit a configuration message for CSI-RS resource settings, the configuration message indicating one or more CSI-RS, where at least one CSI-RS resource is associated with two different time resource types; and receive, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Some implementations of the method and apparatuses described herein may further include a method performed by a NE, the method including transmitting a configuration message for CSI-RS resource settings, the configuration message indicating one or more CSI-RS resources, where at least one CSI-RS resource is associated with two different time resource types; and receiving, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

### BRIEF DESCRIPTION OF THE DRAWINGS

FIG. 1 illustrates an example of a wireless communications system in accordance with aspects of the present disclosure.

FIG. 2 illustrates a scenario for wireless communications.

FIG. 3 illustrates a scenario for wireless communications.

FIG. 4 illustrates a scenario for wireless communications.

FIG. 5 illustrates aperiodic trigger state defining a list of CSI report settings.

FIG. 6 illustrates aperiodic trigger state indicating the resource set and quasi co-location (QCL) information.

FIGS. 7 and 8 illustrate RRC configuration for non-zero power (NZP)-CSI-RS/CSI interference management (IM) resources.

FIG. 9 illustrates partial CSI omission for Rel. 15 physical uplink shared channel (PUSCH)-Based CSI.

FIG. 10 illustrates an example of CSI-RS resource FDRA determination and mapping using two virtual RBs, in accordance with aspects of the present disclosure.

FIG. 11 illustrates examples for handling RBs overlap between a CSI-RS resource FDRA and the UL SB RBs of a SBFD time resource, in accordance with aspects of the present disclosure.

FIG. 12 illustrates an example CSI-RS resource FDRA determination and mapping, in accordance with aspects of the present disclosure.

FIGS. 13, 14, 15, and 16 illustrate examples of FDRA for SBFD with PMI/CQI mapping, in accordance with aspects of the present disclosure.

FIGS. 17 and 18 illustrate example CSI reporting frameworks, in accordance with aspects of the present disclosure.

FIG. 19 illustrates an example of a UE in accordance with aspects of the present disclosure.

FIG. 20 illustrates an example of a processor in accordance with aspects of the present disclosure.

FIG. 21 illustrates an example of a network equipment (NE) in accordance with aspects of the present disclosure.

FIG. 22 illustrates a flowchart of a method performed by a UE in accordance with aspects of the present disclosure.

FIG. 23 illustrates a flowchart of a method performed by a NE in accordance with aspects of the present disclosure.

FIG. 24 illustrates a flowchart of a method performed by a UE in accordance with aspects of the present disclosure.

FIG. 25 illustrates a flowchart of a method performed by a NE in accordance with aspects of the present disclosure.

### DETAILED DESCRIPTION

Wireless communications systems can utilize duplexing modes for transmitting and receiving data, such as at a UE. For instance, time division duplex (TDD) and frequency division duplex (FDD) are two duplexing modes used by some current wireless networks. TDD uses a same carrier frequency and splits the time resources between the DL and UL communications. FDD enables simultaneous UL and DL communications and using different carrier frequencies. Further, full duplex (FD) mode enables simultaneous UL and DL communications over the same carrier frequency and same time resource. FD mode can enable gains and enhancements in terms of increasing the system capacity and coverage and/or reducing latency, such as compared to the half-duplex TDD and FDD modes. However, when using the same time and frequency resources for UL and DL communication such as in FD mode, SI, and cross link interference (CLI) issues can arise which can reduce signal quality and increase signal latency.

Accordingly, the present disclosure provides techniques for CSI reporting and CSI-RS resource allocation to maintain and/or improve the flexibility and signaling overhead of CSI reporting in the FD mode. For instance, an enhanced CSI framework for CSI-RS resource allocation is provided by configuring a contiguous CSI-RS resource allocation by configuring a UE to derive a virtually contiguous FDRA for a CSI-RS resource during the SBFD slots, by wrapping around the frequency resources over two DL sub-bands for example. In one specific example, a physical-to-virtual mapping method is provided for mapping the frequency domain resources into two non-contiguous DL SBs. Advantageously, with the present method, CSI-RS allocation flexibility is maintained and the signaling overhead of the FDRA of the CSI-RS is improved as well. For example, continuous frequency domain resource allocation of a CSI-RS resource in SBFD slots are provided (e.g., when the DL frequency resources of a BWP are distributed between two non-contiguous DL SBs. Further, in some examples, a same CSI-RS resource can be mapped for different types of time resources. In an example, one or more CSI-RS resources are configured for different types of time resources. Alternatively or additionally, one set of CSI-RS resources are configured for a first type of time resource and a second set of CSI-RS resources are configured for a second type of time resources.

The described techniques further provide an enhanced CSI framework for reporting PMI and/or CQI values for SBFD and non-SBFD symbols over a BWP. In an example, common PMI reporting for a sub-band group is provided, whether in DL slot groups or flexible slot groups; and CQI reporting is provided per slot group, e.g., a first CQI value is associated with the DL slot groups and a second CQI value is associated with DL sub-band groups within a flexible slot group. In another example, a mapping of a CSI reporting configuration to an SBFD configuration is provided, where the SBFD configuration identifies a subset of sub-band groups that are associated with UL transmission with a flexible slot group. In another example, a mapping order of CSI fields is provided, where CSI report quantities associated with DL slot groups are given a higher priority order, e.g., reported in earlier available UL resources as compared with CSI report quantities associated with the DL sub-band groups within the flexible slot groups. Thus, the described solutions provide a number of benefits including complexity reduction, overhead reduction, and strong compliance with existing CSI frameworks.

Aspects of the present disclosure are described in the context of a wireless communications system.

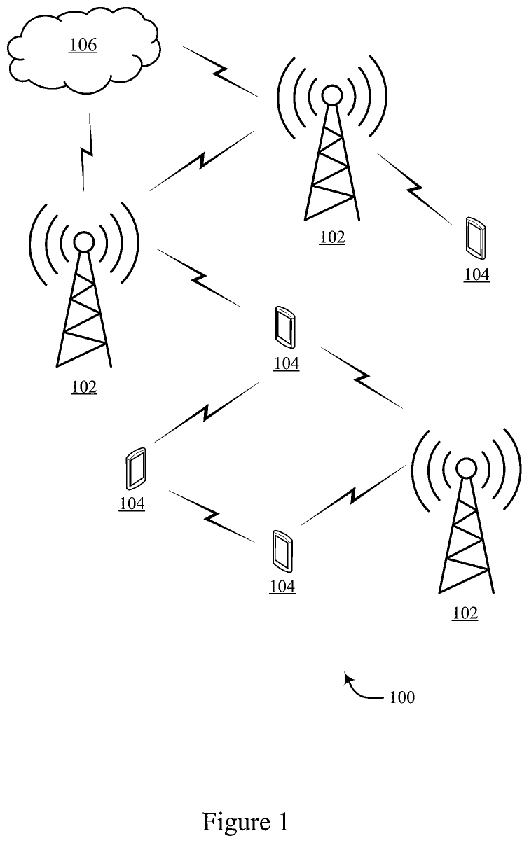

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. Note that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) communicates a configuration signal to a UE 104 including one or more CSI reporting settings, examples of which are described throughout this disclosure. The UE 104 receives the CSI reporting settings along with CSI-RS and generates a CSI report based at least in part on the CSI reporting settings and the CSI-RS. The CSI report includes information such as RI, PMI, and CQI determined from the CSI-RS and based at least in part on the CSI reporting settings. The UE 104 transmits the CSI report to the NE 102 and the NE 102 can utilize information from the CSI report for various purposes, such as optimizing wireless communication between the NE 102 and the UE 104.

With reference to transmission in wireless communications systems, TDD and FDD are two duplexing modes used by current wireless networks. TDD uses the same carrier frequency but splits the time resources between the DL and UL communications. FDD enables simultaneous UL and DL communications, but using different carrier frequencies. Full duplex (FD) mode enables simultaneous UL and DL communications over the same carrier frequency and same time resource.

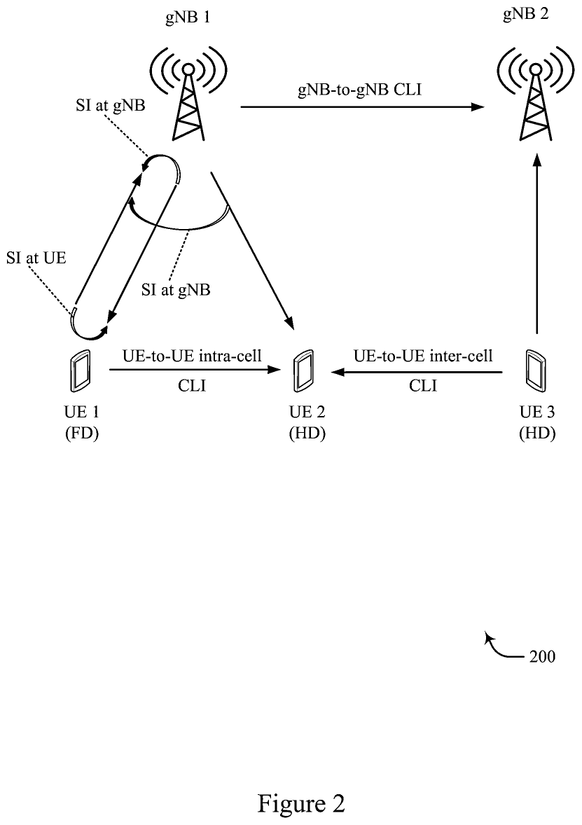

FIG. 2 illustrates a scenario 200 for wireless communications. The scenario 200, for instance illustrates that CLI and SI can occur in a FD mode. In a FD mode, using the same time and frequency resources for UL and DL communications, (e.g., as in FD mode) can cause SI and CLI issues as illustrated in the scenario 200, which are defined as follows.

Self-interference (SI): where the transmitted DL/UL signal by a network node (e.g., gNB or UE) leaks energy onto its received UL/DL signal. As shown in FIG. 2 for example, for the SI at gNB #1, the transmitted DL signal/channel by gNB #1 leaks energy onto its received UL signal/channel, while for the SI at the UE #1, the transmitted UL signal/channel by UE #1 leaks energy onto its received DL signal/channel.

CLI: where the transmitted DL/UL signal by a network node (e.g., gNB or UE) leaks energy onto received UL/DL signal of a nearby node. As shown in FIG. 2 for example, for gNB-to-gNB CLI, e.g., at “victim” gNB #2, the transmitted DL signal/channel by “aggressor” gNB #1 leaks energy onto the received UL signal/channel by “victim” gNB #2. On the other hand, for UE-to-UE CLI, e.g., at “victim” UE #2, for example, the transmitted UL signals/channels by “aggressors” UE #1 and UE #3 leaks energy onto received DL signal/channel at “victim” UE #2.

To optimize usage of the FD mode, SI and CLI are to be properly managed. One solution to the SI and CLI issues is to split the frequency resources of a time resource into non-overlapping DL and UL sub-bands (SBs), where each sub-band includes one or more resource-blocks (RBs). Such an approach can reduce the impact of SI and CLI and has been introduced as a study item within 3GPP Rel-18 and called non-overlapping SBFD.

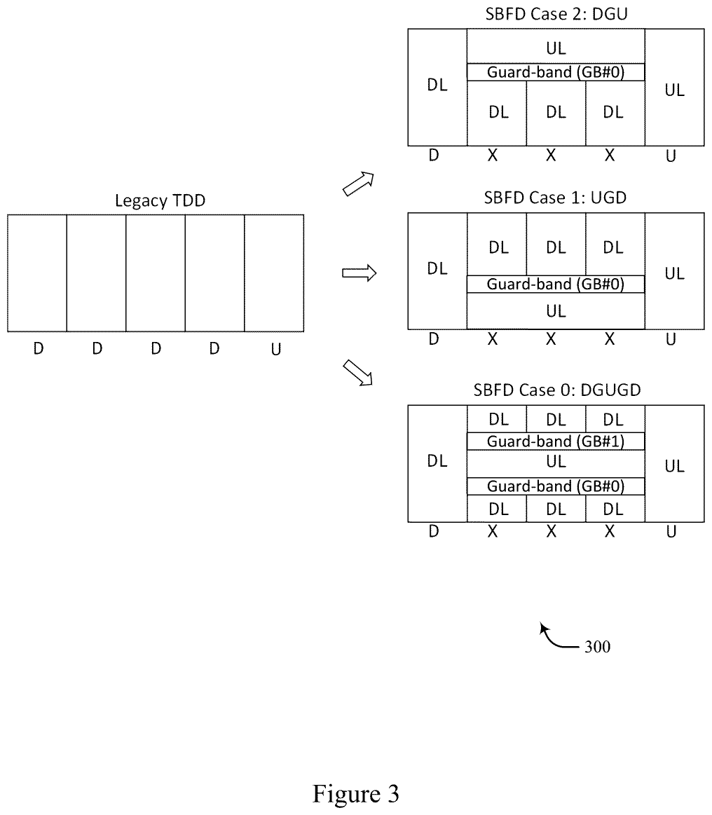

FIG. 3 illustrates a scenario 300 for wireless communications. The scenario 300, for example, illustrates time slot resources in a legacy TDD mode versus three different FD mode configurations. In time domain, for instances, some of the time resources (e.g., symbols or slots) may be used for SFBD communications (e.g., slots labeled ‘X’), while others can be used for half-duplex (HD) DL (e.g., slots labeled ‘D’) or UL (e.g., slots labeled ‘U’) communications. As exemplified in FIG. 3, the time-domain resources (symbols/slots) with UL and DL SBs can also be referred to herein as “SBFD symbols/slots” (labeled ‘X’), and the DL-only/UL-only symbols/slots, e.g., without UL or DL SBs, respectively, can be referred herein as “non-SBFD symbols/slots.” As noted earlier, a Rel-18 SBFD scheme is proposed to overcome issues encountered by the legacy TDD scheme (e.g., reduced UL coverage, reduced UL capacity, and increased UL latency) by splitting the frequency domain resources of one or more of DL and/or flexible (F) symbols/slots into non-overlapping DL and UL sub-bands and therefore increasing the allocated time and frequency resources of UL communications.

For example, FIG. 3 shows a reconfiguration examples of a DDDDU legacy TDD slot configuration into three DXXXU SBFD slot configurations, where the frequency domain of X slots (e.g., SBFD slots) is divided into non-overlapping DL and UL sub-bands. As illustrated, an SBFD-based configuration allocates more UL resources to UL communications as compared to legacy TDD, which can increase the UL communications capacity and coverage. Moreover, the UL frequency resources with SBFD-based configuration are available starting from slot #1 (e.g., the first slot labeled ‘X’) as opposed to the legacy TDD-based configuration, where the UL frequency resources are available at slot #4 (e.g., the slot labeled ‘U’). Thus, the SBFD-based configurations facilitate improving/reducing the UL communications latency as compared to the legacy TDD-based configuration.

In wireless communication systems, CSI estimation enables efficient transmission and reception schemes. For example, a network node (e.g., a gNB) can use knowledge of CSI information, e.g., to determine efficient precoding/beamforming matrices (e.g., spatial filters), user and time-frequency resources scheduling, link-adaptation strategies, etc.

In 5G NR, a UE could be configured to report some CSI quantities to its serving network node(s), depending on the configuration, including RI, PMI, CQI, etc. To facilitate this, in examples, a UE can be configured by its serving network node(s) with a set of CSI report settings (e.g., CSI-ReportConfig) and a set of CSI-RSs resource settings (e.g., CSI-ResourceConfig), where each CSI report setting is associated with one or more of CSI resource settings for either channel measurement or interference measurement.

In examples, a configured CSI report setting defines the content of CSI report in terms of (1) what CSI quantities to report (e.g., RI, PMI, CQI, etc.), (2) the frequency granularity of reported information (e.g., wideband reporting or sub-band reporting), and (3) the time domain behavior of reported information (e.g., periodic, aperiodic, or semi-persistent reporting). It is noted that, in some examples, the sub-band for CSI reporting has a different definition with respect to UL and DL sub-bands in the SBFD mode.

In examples, a CSI resource setting defines the CSI resources in terms of (1) by and/or over which resources the CSI information to be computed (e.g., NZP CSI-RS and/or CSI-IM resources), (2) the time domain behavior of CSI resources (e.g., periodic, aperiodic, or semi-persistent reporting), 3) the time domain resources over which the CSI resources are allocated (e.g., symbols/slots indexes and/or slots/symbols offset), and (4) the frequency domain resources over which the CSI resources are allocated (e.g., on every RB or on every other RB).

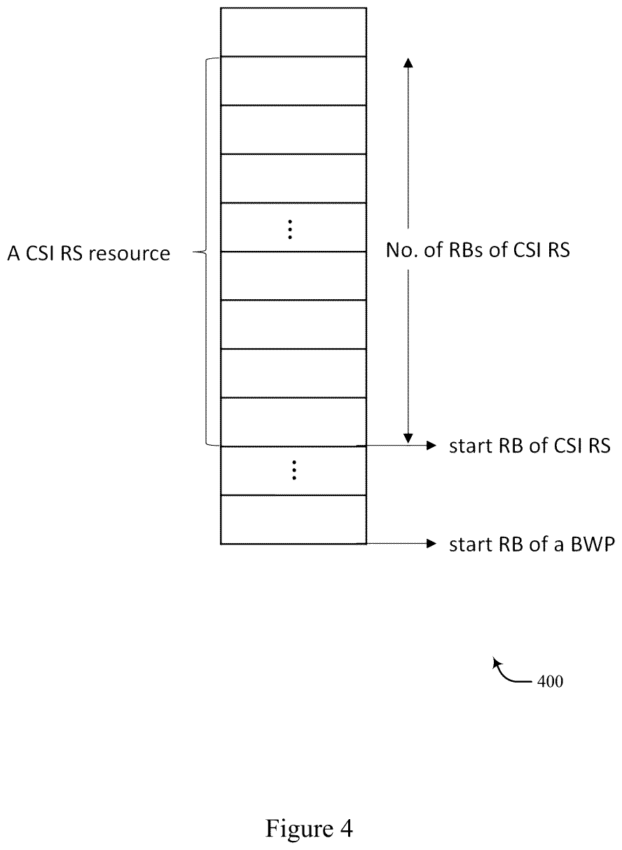

FIG. 4 illustrates at 400 an example contiguous FDRA of a CSI resource. In examples, a CSI-RS resource is allocated using a contiguous FDRA scheme in the form of “start RB” and “number of RBs”, as exemplified in FIG. 4. However, as exemplified by the SBFD Case 0 of FIG. 3, the total DL RBs within a SBFD slot (e.g., an X slot) are distributed over two DL SBs, and therefore, current contiguous FDRA schemes may be unable to allocate a single CSI-RS resource over the two DL SBs.

Specifically, one possible option for resolving this issue involves configuring two CSI-RS resources, where each configures a set of consecutive RBs for CSI-RS transmission per DL sub-band. However, this option may use additional signaling to link two CSI-RS resources in the two DL sub-bands and may reduce the flexibility of CSI-RS configuration since this option would double the number of CSI-RS resources, which are limited in current specifications. Another possible option resolves this latter issue by configuring one CSI-RS resource with non-contiguous FDRA across two DL sub-bands, but may use a new RRC structure and additional signaling overhead. Finally, another option is to reuse the existing signaling design for CSI-RS resource configuration by configuring one contiguous CSI-RS resource allocation, where the UE would derive the non-contiguous CSI-RS resource by excluding the frequency resources outside DL sub-band(s), but this option limits the CSI-RS resource allocation since it can allocate CSI-RS frequency-domain resources in the inner sides of the two DL sub-bands. Accordingly, the present disclosure provides enhancements (or new options) to the FDRA of current CSI-RS framework while maintaining and/or improving the flexibility signaling overhead associated with the current framework.

In aspects of this disclosure, the following 3GPP Rel-18 agreements are taken into consideration.

With reference to “Agreement in RAN1 #112,” study of the frequency resource allocation for CSI-RS across DL sub-ands for SBFD-aware UEs considering the following options. Option 1: Two contiguous CSI-RS resources that are linked; Option 2: One CSI-RS resource; Option 2-1: Non-contiguous CSI-RS resource allocation; and Option 2-2: One contiguous CSI-RS resource allocation with non-contiguous CSI-RS resource derived by excluding frequency resources outside DL sub-band (s).

With reference to “Conclusion in “RAN #112bis”, for the options agreed to study in RAN1 #112 for frequency resource allocation for CSI-RS across DL sub-bands for SBFD-aware UEs, the following observations are agreed. For the options, there is no impact on CSI-RS sequence generation. Option 1 may use additional signaling to link two CSI-RS resources in two DL sub-bands. Option 2-1 may use a new RRC structure to configure non-contiguous RBs for one CSI-RS resource, which may require additional signaling overhead. Option 2-2 can reuse the existing signaling design for CSI-RS resource configuration. Option 2-2 can be used to resolve the potential unaligned boundaries between CSI-RS resource configuration and SBFD sub-bands.

With reference to “Agreement in RAN #112”, For SBFD-aware UEs, study the following options for CSI report associated with periodic/semi-persistent CSI-RS, at least, across SBFD symbols and non-SBFD symbols in different slots (each CSI-RS resource within a slot has either all SBFD or all non-SBFD symbols). Option 1: separate CSI reporting for SBFD symbols and non-SBFD symbols. Option 2: same CSI reporting for SBFD symbols and non-SBFD symbols.

With reference to “Agreement in RAN #112bis,” for semi-static SBFD, for a CSI-RS resource which overlaps with SBFD sub-band boundaries, CSI-RS resources within DL sub-band(s) are valid for SBFD-aware UE. For semi-static SBFD, for a CSI reporting sub-band which overlaps with SBFD sub-band boundaries, CSI report is derived based on CSI-RS resources excluding CSI-RS resources outside DL sub-band(s). Further, For SBFD-aware UEs, the following options for CSI report associated are to be considered with periodic/semi-persistent CSI-RS in case the periodicity is such that CSI-RS instances occur in both SBFD and non-SBFD symbols. Option 1: two CSI-ReportConfigs, where one is associated with SBFD symbols and the other is associated with non-SBFD symbols. Option 1-1: One CSI-ReportConfig is associated with a CSI-RS restricted to SBFD symbols and the second CSI-ReportConfig is associated with a second CSI-RS restricted to non-SBFD symbols; Option 1-2: Both CSI-ReportConfigs are associated with the same CSI-RS. The CSI report associated with one CSI-ReportConfig is derived based on CSI-RS instances in SBFD symbols. The CSI report associated with the second CSI-ReportConfig is derived based on CSI-RS instances in non-SBFD symbols. Option 2: one CSI-ReportConfig associated with both SBFD symbols and non-SBFD symbols. Option 2-1: One CSI-ReportConfig is associated with two CSI-RSs which are restricted to SBFD symbols and non-SBFD symbols respectively. Separate CSI measurements are derived based on the first and second CSI-RSs respectively. Option 2-2: One CSI-ReportConfig is associated with one CSI-RS. The CSI report is derived based on CSI-RS which can be in SBFD symbols or non-SBFD symbols in different time instances. Note that whether the CSI-RS resource can be used for SBFD and non-SBFD symbols may depend on, e.g., gNB implementation of same/different antenna configuration in both symbols. Further, option 1-1 can be supported according to existing specification by gNB configuration of appropriate periodicities to ensure that the CSI-RS associated with each CSI-ReportConfig is confined to either SBFD symbols or non-SBFD symbols. But it may restrict the gNB configuration flexibility and enhancements can be considered by additional indication or rules to determine the CSI-RS is valid within one symbol type and is invalid in the other symbol type. Further, option 2-2 can be supported according to existing specification to configure measurement restriction so that UE would not average CSI measurements across SBFD and non-SBFD symbols.

Note that in “RAN #112bis-e,” four CSI reporting options were agreed to be studied for CSI reports associated with periodic/semi-persistent CSI-RS resource across SBFD and non-SBFD slots/symbols, (see “Agreement in RAN #112bis” above). With Option 1-1, each slot type has a separate CSI report and a separate CSI RS resource, while with Option 1-2, each slot type has a separate CSI report but a common CSI RS resource. With Option 2-1, each slot type has a separate CSI resource but a common CSI report, whereas with Option 2-2, both slot types have a common CSI resource and a common CSI report. In general, each option has advantages and disadvantages. For example, Option 1-1 can be expected to provide more accurate measurements and reports, but as noted in the agreement, it may restrict the gNB configuration flexibility. On the other hand, the other options may not work if gNB uses different antenna configuration in SBFD and non-SBFD slots, since in this case, the number of CSI-RS ports and codebook configuration may be different between different slot types.

In various examples, relevant and/or alternative solutions include the reuse of Rel-18 NES-based CSI reporting framework. For example, under this framework, a UE is configured with a CSI reporting configuration including multiple CSI reporting sub-configurations, where each CSI reporting sub-configuration is associated with a distinct CSI sub-report, the multiple CSI sub-reports are mapped to a same CSI report corresponding to the CSI reporting configuration. A similar approach can be adopted with the DL-only slots and flexible (e.g., SBFD) slots corresponding to two sub-configurations. However, such an approach may be associated with large CSI feedback overhead since the correlation between the CSI report quantities across the two slot groups is not exploited. In another example, following the Rel-18 SBFD SI outline is considered. For example, separate CSI reporting for SBFD symbols and non-SBFD symbols (e.g., Option 1) or same CSI reporting for both SBFD symbols and non-SBFD symbols (e.g., Option 2) is considered. However, with this approach, the outline is at a high level, with no clear emphasis on the CSI report quantities included in the CSI report and the corresponding mapping of these CSI report quantities to SBFD symbols and non-SBFD symbols.

The following provides a summary of NR codebook types and additional details can be found in 3GPP Technical Specification (TS) 38.214, “Physical layer procedures for data,” December 2022, hereinafter referenced as [1]. For NR Rel. 15 Type-II codebook, assume the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band consists of a set of RBs, each RB consisting of a set of subcarriers. Considering dual-polarization, there are 2N₁N₂ CSI-RS ports are utilized to enable DL channel estimation with high resolution for NR Rel. 15 Type-II codebook. In order to reduce feedback overhead in Uplink (UL), a Discrete Fourier transform (DFT)-based transformation is used to project the channel onto L spatial beams (shared by both polarizations) where L<N₁N₂. In the sequel the indices of the L beams are referred as the Spatial Domain (SD) basis indices. The magnitude and phase values of the 2L linear combination coefficients for each sub-band are fed back to the gNB as part of the CSI report. The 2N₁N₂×N₃ codebook per layer l takes on the form

Wₗ=W₁W_{2,l},
where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ are “oversampling factors”, assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. The indices of the L selected columns in B are reported, along with the oversampling index taking on O₁O₂ values. Note that W_{2,l} are independent across different layers.

For NR Rel. 15 Type-II Port Selection Codebook, K (where K≤2N1N2) beamformed CSI-RS ports are utilized in DL transmission, in order to reduce complexity. The K×N3 codebook matrix per layer takes on the form:

Wₗ=W₁^{PS}W_{2,l}.

Here, W_{2,l} follow the same structure as the conventional NR Rel. 15 Type-II Codebook and are layer specific. W₁^{PS} is a K×2L block-diagonal matrix with two identical diagonal blocks, e.g.,

$${W}_{1}^{PS} = [ \begin{matrix}E & 0 \\ 0 & E\end{matrix} ] ,$$

and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the ith location. Here dPS is a radio resource control (RRC) parameter which takes on the values {1, 2, 3, 4} under the condition dPS≤min(K/2, L), whereas mPS takes on the values

$$\{ 0 , … , ⌈ \frac{K}{2 {d}_{PS}} ⌉ - 1 \}$$

and is reported as part of the UL CSI feedback report. W₁^{PS} is common across layers.

For K=16, L=4 and dPS=1, the 8 possible realizations of E corresponding to mPS={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , \\ [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When dPS=2, the 4 possible realizations of E corresponding to mPS={0, 1, 2, 3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When dPS=3, the 3 possible realizations of E corresponding of mPS={0, 1, 2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When dPS=4, the 2 possible realizations of E corresponding of mPS={0, 1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, mPS parametrizes the location of the first 1 in the first column of E, whereas dPS represents the row shift corresponding to different values of mPS.

NR Rel. 15 Type-I codebook is the baseline codebook for NR, with a variety of configurations. One utility of Rel. 15 Type-I codebook is a special case of NR Rel. 15 Type-II codebook with L=1 for RI=1, 2, where a phase coupling value is reported for each sub-band, e.g., W_{2,l} is 2×N3, with the first row equal to [1, 1, . . . , 1] and the second row equal to [e^{j2πØ}^{₀}, . . . , e^{j2πØ}^{_{N3-1}}]. Under specific configurations, ϕ0=ϕ1 . . . =ϕ, e.g., wideband reporting. For RI>2 different beams are used for each pair of layers. The NR Rel. 15 Type-I codebook can be depicted as a low-resolution version of NR Rel. 15 Type-II codebook with spatial beam selection per layer-pair and phase combining. More details on NR Rel. 15 Type-I codebook can be found in R1-1709232, Samsung et al., “WF on Type I and II CSI codebooks,” Hangzhou, China, May 15-19, 2017, hereinafter referenced as [2].

For NR Rel. 16 Type-II Codebook, assume the gNB is equipped with a two-dimensional (2D) antenna array with N1N2 antenna ports per polarization (N1 being the horizontal and N2 the vertical dimension of the array). In the frequency domain, communication occurs over N3 PMI sub-bands, where a sub-band consists of a set of RBs, each RB consisting of a set of subcarriers. Considering dual-polarization, there are 2N1N2 CSI-RS ports are utilized to enable DL channel estimation with high resolution for NR Rel. 16 Type-II codebook. In order to reduce feedback overhead in Uplink (UL), a DFT-based transformation is used to project the channel onto L spatial beams (shared by both polarizations) where L<N1N2. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N1N2×N3 codebook per layer takes on the form:

Wₗ=W₁\tilde{W}_{2,l}W_{f,l}^{H},

where W1 is a 2N1N2×2L block-diagonal matrix (L<N1N2) with two identical diagonal blocks, e.g.,

$${W}_{1} = [ \begin{matrix}B & 0 \\ 0 & B\end{matrix} ] ,$$

and B is an N1N2×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ oversampling factors are assumed for the 2D DFT matrix from which matrix B is drawn. Note that W₁ is common across layers. W_{f,l} is an N3×M matrix (M<N3) with columns selected from a critically-sampled size-N3 DFT matrix, as follows:

$${W}_{f , l} = [ \begin{matrix}{f}_{{k}_{0}} & {f}_{{k}_{1}} & … & {f}_{{k}_{M ′ - 1}}\end{matrix} ] , 0 \leq {k}_{i} \leq {N}_{3} - 1 , \\ {f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

The indices of the L selected columns in B are reported, along with the oversampling index taking on O₁, O₂ values. Similarly, for W_{f,l}, the indices of the M selected columns out of the predefined size-N3 DFT matrix are reported. In the sequel the indices of the M dimensions are referred to as the selected Frequency Domain (FD) basis indices. Hence, L, M represent the equivalent spatial and frequency dimensions after compression, respectively. Finally, the 2L×M matrix \tilde{W}_{2,l} represents the linear combination coefficients (LCCs) of the spatial and frequency DFT-basis vectors of layer l. Both \tilde{W}_{2,l}, W_{f,l} are selected independent for different layers. Amplitude and phase values of an approximately R fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, which is much less than the total number of CSI coefficients 2N1N2×N3.

For NR Rel. 16 Type-II Port Selection Codebook, K (where K≤2N1N2) beamformed CSI-RS ports are utilized in DL transmission, in order to reduce complexity. The K×N3 codebook matrix per layer takes on the form as discussed in [1].

Wₗ=W₁^{PS}\tilde{W}_{2,l}W_{f,l}^{H}.

Here, W_{2,l} and Wf,l follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

The NR Rel. 17 Type-II Port Selection Codebook follows a similar structure as that of Rel. 15 and Rel. 16 port-selection codebooks, as follows:

Wₗ=W̅₁^{PS}\tilde{W}_{2,l}W_{f,l}^{H}.

However, unlike Rel. 15 and Rel. 16 Type-II port-selection codebooks, the port-selection matrix W̅₁^{PS} is supports free selection of the K ports, or more precisely the K/2 ports per polarization out of the N1N2 CSI-RS ports per polarization, e.g.

$$⌈ {log}_{2} ( \begin{matrix}{N}_{1} {N}_{2} \\ K / 2\end{matrix} ) ⌉$$

bits are used to identify the K/2 selected ports per polarization, where this selection is common across layers. Here, \tilde{W}_{2,l} and Wf,l follow the same structure as the conventional NR Rel. 16 Type-II Codebook, however M may be limited to {1, 2}, with the network configuring a window of size N∈{2, 4} for M=2. Moreover, the bitmap is reported unless β=1 and the UE can report the coefficients for a rank up to a value of two.

For CSI reporting the codebook report is partitioned into two parts based on the priority of information reported. Each part is encoded separately (Part 1 has a possibly higher code rate). Below we list the parameters for NR Rel. 16 Type-II codebook. More details can be found in clause 5.2.3-4 of [1].

For content of a CSI report: Part 1: RI+CQI+Total number of coefficients; Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be used to allow dynamic reporting size for codebook based on available resources in the UL phase. More details can be found in clause 5.2.3 of [1].

Also Type-II codebook is based on aperiodic CSI reporting, and reported in PUSCH via DL control information (DCI) triggering (one exception). Type-I codebook can be based on periodic CSI reporting (e.g., physical uplink control channel (PUCCH)) or semi-persistent CSI reporting (PUSCH or PUCCH) or aperiodic reporting (PUSCH).

For priority reporting for CSI Part 2, note that multiple CSI reports may be transmitted with different priorities, as shown in Table 1 below. The priority of the NRep CSI reports are based on the following: A CSI report corresponding to one CSI reporting setting for one cell may have higher priority compared with another CSI report corresponding to one other CSI reporting setting for the same cell; CSI reports intended to one cell may have higher priority compared with other CSI reports intended to another cell; CSI reports may have higher priority based on the CSI report content. For example, CSI reports carrying Layer 1 reference signal received power (L1-RSRP) information have higher priority; CSI reports may have higher priority based on their type. For example, whether the CSI report is aperiodic, semi-persistent or periodic, and whether the report is sent via PUSCH or PUCCH, may impact the priority of the CSI report.

In light of these, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting setting index, and Ms: Maximum number of CSI reporting settings
c: Cell index, and Ncells: Number of serving cells
k: 0 for CSI reports carrying L1-RSRP or Layer 1 signal-to-interference-and-noise ratio (L1-SINR), 1 otherwise;
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI
Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

For triggering aperiodic CSI reporting on PUSCH, a UE is to report CSI information for the network using the CSI framework in NR Release 15. The triggering mechanism between a report setting and a resource setting can be summarized in Table 2 below.

TABLE 2
Triggering mechanism between a report setting and a resource setting

| | | | | Access |
|---|---|---|---|---|
| | | | | Point |
| | | Periodic CSI | Semi-Persistent (SP) CSI | (AP) CSI |
| | | reporting | reporting | Reporting |
| Time Domain | Periodic CSI-RS | RRC configured | MAC control element (CE) | DCI |
| Behavior of | | | (PUCCH) | |
| Resource Setting | | | DCI (PUSCH) | |
| | SP CSI-RS | Not Supported | MAC CE (PUCCH) | DCI |
| | | | DCI (PUSCH) | |
| | AP CSI-RS | Not Supported | Not Supported | DCI |

Moreover: Associated Resource Settings for a CSI Report Setting may have same time domain behavior; Periodic CSI-RS/IM resource and CSI reports may be assumed to be present and active once configured by RRC; Aperiodic and semi-persistent CSI-RS/IM resources and CSI reports may be explicitly triggered or activated; Aperiodic CSI-RS/IM resources and aperiodic CSI reports, the triggering can be done jointly by transmitting a DCI Format 0-1; Semi-persistent CSI-RS/IM resources and semi-persistent CSI reports can be independently activated.

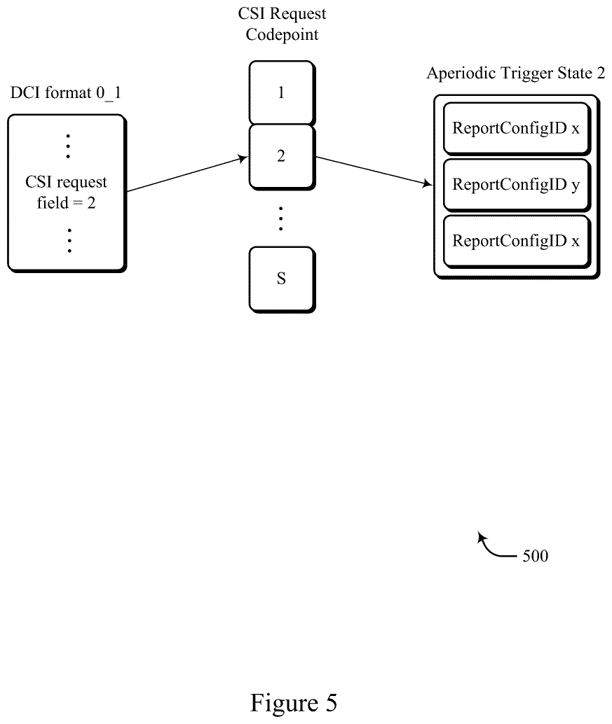

FIG. 5 illustrates at 500 aperiodic trigger state defining a list of CSI report settings. For aperiodic CSI-RS/IM resources and aperiodic CSI reports, the triggering is done jointly by transmitting a DCI Format 0-1. The DCI Format 0_1 includes a CSI request field (0 to 6 bits). A non-zero request field points to a so-called aperiodic trigger state configured by RRC (see, e.g., FIG. 2). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

When the CSI Report Setting is linked with aperiodic Resource Setting (can include multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE assumes that the resources used for the computation of the channel and interference can be processed with the same spatial filter e.g. quasi-co-located with respect to “QCL-TypeD.”

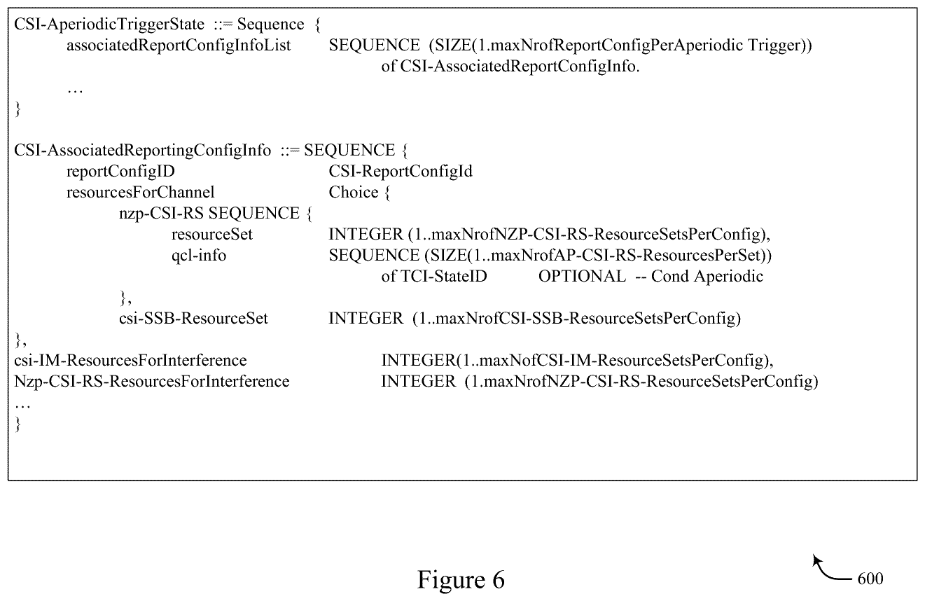

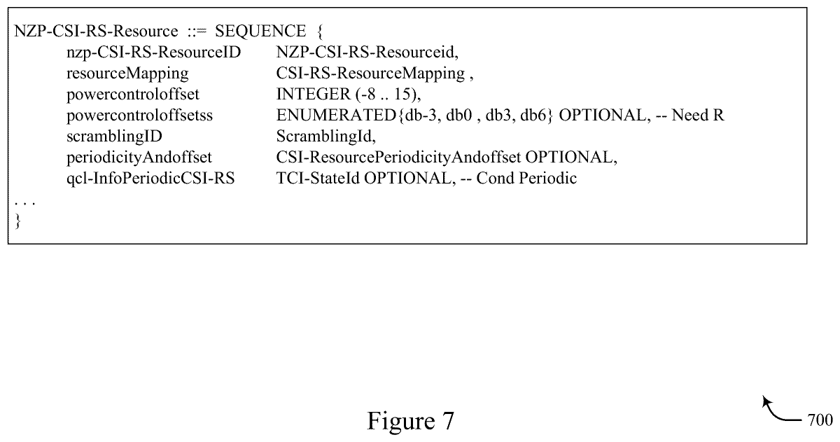

FIG. 6 illustrates at 600 aperiodic trigger state indicating the resource set and QCL information. FIGS. 7 and 8 illustrate RRC configuration for NZP-CSI-RS/CSI-IM resources. For instance, 700 illustrates RRC configuration for NZP-CSI-RS Resource and 800 illustrates RRC configuration for CSI-IM-Resource.

Table 3 summarizes the type of UL channels used for CSI reporting as a function of the CSI codebook type.

TABLE 3
Uplink channels used for CSI reporting as a function of the CSI codebook type

| | Periodic CSI reporting | SP CSI reporting | AP CSI reporting |
|---|---|---|---|
| Type I Wideband | PUCCH Format 2, 3, 4 | PUCCH Format 2 | PUSCH |
| (WB) | | PUSCH | |
| Type I Subband | | PUCCH Format 3, 4 | PUSCH |
| (SB) | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case uplink control information (UCI) payload size design would result in large overhead. CSI Part 1 has a fixed payload size (and can be decoded by the gNB without prior information) and includes the following: RI (if reported), CSI-RS Resource Index (CRI) (if reported) and CQI for the first codeword; number of non-zero wideband amplitude coefficients per layer for Type II CSI feedback on PUSCH.

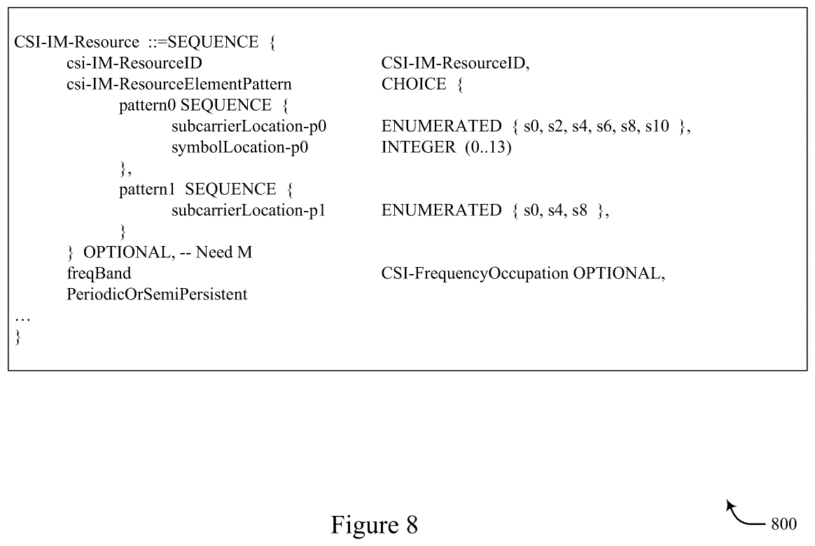

FIG. 9 illustrates at 900 partial CSI omission for Rel. 15 PUSCH-Based CSI. CSI Part 2 has a variable payload size that can be derived from the CSI parameters in CSI Part 1 and includes PMI and the CQI for the second codeword when RI>4. For example, if the aperiodic trigger state indicated by DCI format 0_1 defines 3 report settings x, y, and z, then the aperiodic CSI reporting for CSI part 2 can be ordered as indicated in FIG. 6.

As mentioned earlier, CSI reports are prioritized according to: time-domain behavior and physical channel, where more dynamic reports are given precedence over less dynamic reports and PUSCH has precedence over PUCCH; CSI content, where beam reports (e.g., L1-RSRP reporting) has priority over regular CSI reports; the serving cell to which the CSI corresponds (in case of carrier aggregation (CA) operation). CSI corresponding to the primary cell (PCell) has priority over CSI corresponding to secondary cells (Scells); the reportConfigID.

For CQI reporting a CSI report may include a CQI report quantity corresponding to channel quality assuming a target maximum transport block error rate, which indicates a modulation order, a code rate and a corresponding spectral efficiency associated with the modulation order and code rate pair. Examples of the maximum transport block error rates are 0.1 and 0.00001. The modulation order can vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate and efficiency is provided in Table 4 below, as follows.

A CQI value may be reported in two formats: a wideband format, where one CQI value is reported corresponding to each physical downlink shared channel (PDSCH) transport block, and a subband format, where one wideband CQI value is reported for the transport block, in addition to a set of subband CQI values corresponding to CQI subbands on which the transport block is transmitted. CQI subband sizes are configurable, and depends on the number of physical resource blocks (PRBs) in a bandwidth part, as shown in Table 5.

TABLE 4
Example of a 4-bit CQI table

| CQI | | code rate x | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 5
Configurable subband sizes for a given BWP size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each sub-band s, a 2-bit sub-band differential CQI value is reported, defined as:

Sub-band Offset level(s)=sub-band CQI index(s)−wideband CQI index.

The mapping from the 2-bit sub-band differential CQI values to the offset level is shown in Table 6 as follows:

TABLE 6
Mapping sub-band differential CQI value to offset level

| Sub-band differential CQI | |
|---|---|
| value | Offset level |
| 0 | 0 |
| 1 | 1 |
| 2 | ≥2 |
| 3 | <−1 |

Also, note that multiple tables corresponding to mapping CQI indices to modulation and coding schemes may exist. For instance, Table 7 below may correspond to a first CQI table with modulation and coding schemes that correspond to enhanced Mobile BroadBand (eMBB)-based transmission, whereas Table 8 below of the CQI may correspond to a first CQI table with modulation and coding schemes that correspond to ultra-reliable low-latency communication (URLLC)-based transmission. Note that eMBB-based DL transmission and URLLC-based DL transmission correspond to two different thresholds of transport block error probability, where the threshold of the transport block error probability corresponding to the URLLC-based DL transmission, e.g., 0.00001 is lower than the threshold of the transport block error probability corresponding to the eMBB-based DL transmission, e.g., 0.1.

TABLE 7
CQI Table corresponding to eMBB-based DL transmission

| CQI | | code rate x | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 8
CQI Table corresponding to URLLC-based DL transmission

| CQI | | code rate x | |
|---|---|---|---|
| index | modulation | 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

In aspects of this disclosure, an improved design similar to the signaling design described for CSI-RS resource configuration above is described. In an example, a proposed system involves configuring a contiguous CSI-RS resource allocation (e.g., similarly to “Option 2-2” above). However, unlike Option 2-2, the methods and systems described herein (e.g., an “Option 2-3”) involve configuring a UE to derive a virtually contiguous FDRA for a CSI-RS resource during the SBFD slots (e.g., ‘X’ slots) by wrapping-around the frequency resources over the two DL sub-bands. In this way, for example, CSI-RS allocation flexibility is maintained and/or improved as well as the signaling overhead of the FDRA of CSI-RS. Thus, some examples herein include (e.g., as an “Option 2-3”) providing one contiguous CSI-RS resource allocation with contiguous CSI-RS resource derived by wrapping around the frequency resources over the two DL sub-bands.

In examples, the following notational assumptions are presented for convenience: a slot group is a set of contiguous slots of a same type (e.g., ‘DL or ‘D’, ‘UL’ or ‘U’, ‘X’ or flexible ‘U’, etc.). Symbols of a DL slot group and non-SBFD symbols for DL, and ‘D’ symbol/slot may be used interchangeably and/or may be considered equivalent. DL symbols of a flexible slot group and SBFD symbols, and ‘X’ symbol/slot may be used interchangeably and/or may be considered equivalent. A set of contiguous RBs/sub-carriers of a same type, e.g., DL or UL, in a flexible slot group correspond to a sub-band group. A time resource may correspond to a symbol or a slot, and a time resource type may correspond to a ‘D’ symbol/slot, a ‘U’ symbol/slot, or an ‘X’ symbol/slot.

In aspects of this disclosure, techniques are disclosed to enable enhanced CSI resource allocation. In examples, a UE receives, from its serving network node (e.g., a serving gNB), a CSI-RS resource configuration message including one or more of CSI-RS resource settings. In examples, the one or more CSI-RS resource settings are applicable for both time resources (symbols/slots) types, e.g., non-SBFD and SBFD.

In an example, during a non-SBFD time resource, a UE determines the contiguous FDRA of a configured CSI-RS resource using the corresponding start-RB and number-of-RBs parameters, where the UE uses the physical RBs numbering of the corresponding BWP PRBs determined using an RBs numbering method to determine the FDRA of the CSI-RS resource.

In an example, during a SBFD time resource, a UE determines the contiguous FDRA of a configured CSI-RS resource using the corresponding start-RB and number-of-RBs parameters. In this example, the UE uses a virtual RBs numbering of the corresponding BWP PRBs to determine the FDRA of the CSI RS resource. In some implementations, the virtual RBs numbering of the corresponding BWP PRBs is preconfigured.

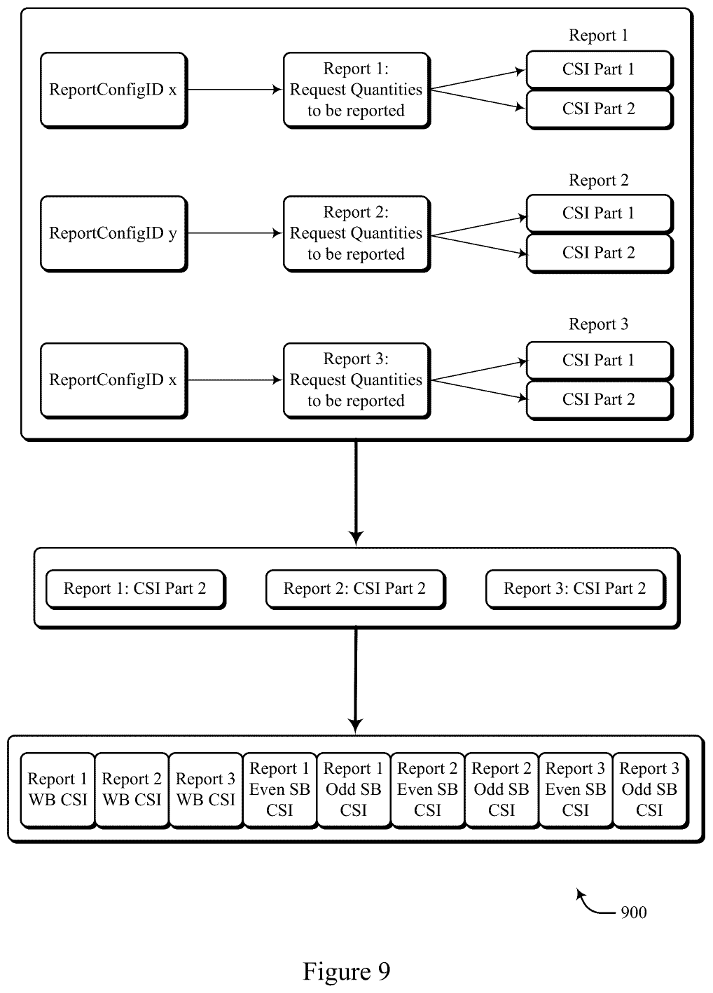

FIG. 10 illustrates an example 1000 of CSI-RS resource FDRA determination and mapping using two virtual RBs numbering methods of PRBs of a BWP, in accordance with aspects of the present disclosure. In this example, the virtual RBs numbering of the corresponding BWP PRBs is determined using an indicated virtual numbering method (e.g., Method 1 or Method 2).

In some implementations of Method 1, a mapping of a PRB i_{PRB} to a virtual RB i_{VRB} is obtained as:

$${i}_{VRB} = mod ( {i}_{PRB} - {v}_{startRB} , {n}_{PRB} )$$

where V_{startRB} is the start RB (e.g., V_{startRB}=9 in the corresponding example of FIG. 10), n_{PRB} is the total number of PRBs of the corresponding BWP (e.g., n_{PRB}=13).

In some implementations of Method 2 of the illustrated example, a mapping of a PRB i_{PRB} to a VRB i_{VRB} is obtained as:

$${i}_{VRB} = mod ( {v}_{startRB} - {i}_{PRB} , {n}_{PRB} )$$

where V_{startRB} is the start RB (e.g., V_{startRB}=5 in the corresponding example of FIG. 10), n_{PRB} is the total number of PRBs of the corresponding BWP (e.g., n_{PRB}=13 in 10).

In some implementations, the start RB V_{startRB}, the total number of PRBs of the corresponding BWP, and/or the indexes of PRBs {i_{PRB}} are indicated within the configuration message. In some other examples, one or more of these parameters are provided to the UE or determined by the UE based on an independent configuration message, e.g., from a provided BWP configuration message and/or from a provided SBFD time-frequency configuration message.

In some implementations, the mapping of PRBs to VRBs is performed based on a PRBs Group to a VRBs Group. For example, each PRB/VRB Group includes one or more of PRBs/VRBs and where the grouping level (e.g., the number of PRBs/VRBs within a group) is either preconfigured, e.g., based on a corresponding BWP size as shown in Table 9, or indicated to the UE within the configuration message.

TABLE 9
BWP size versus No. of PRBs within a PRB Group

| BWP size (PRBs) | No. of PRBs within a PRB Group |
|---|---|
| 24-72 | 8, 16 |
| 73-144 | 16, 24 |
| 145-275 | 32, 48 |

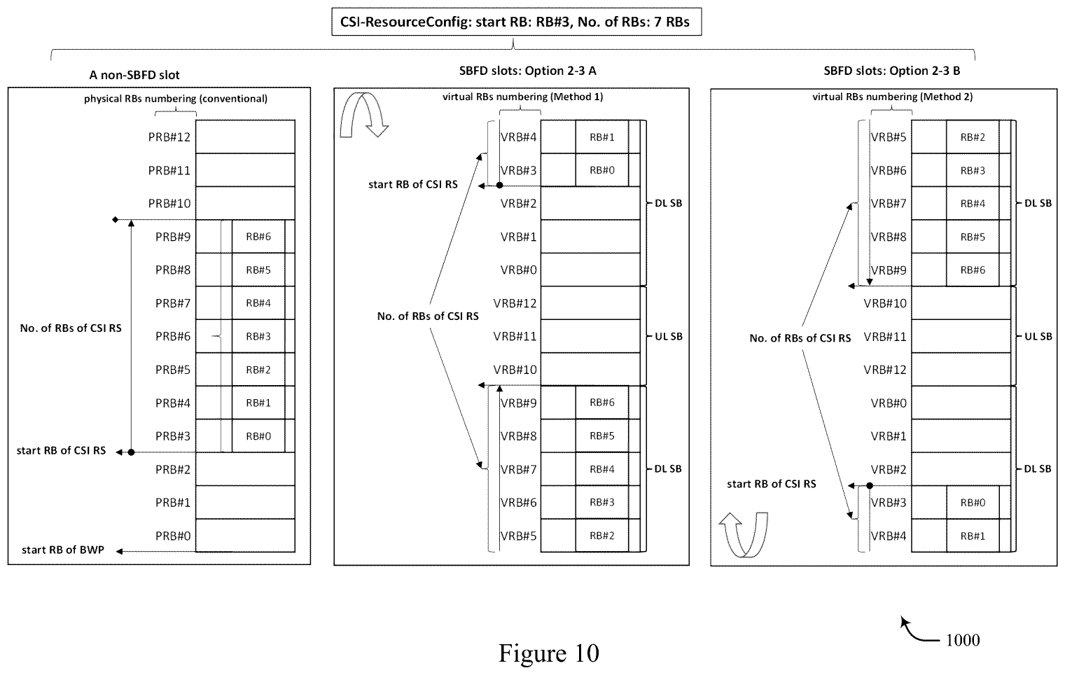

FIG. 11 illustrates an example 1100 of two options for handling RBs overlap between a CSI-RS resource FDRA and the UL SB RBs of a SBFD time resource, in accordance with aspects of the present disclosure. In some implementations, when mapping the RBs of a corresponding CSI RS resource on the VRBs determined using either method (e.g., Method 1 or Method 2), one or more of RBs of the corresponding CSI RS resource may overlap with the UL SB RBs of a SBFD time resource (symbol/slot). In this case, the UE may use a combination of the following schemes (options/methods) to overcome or to resolve the overlapped RBs. In an example (“Scheme #1”), the RBs of the corresponding CSI RS resource that overlap with the UL SB RBs, e.g., the RBs outside the DL subband(s), are excluded as exemplified in “Option 2-3 A1” of FIG. 11. In an example (“Scheme #2”), an offset RBs is applied to the start RB parameter of the CSI RS resource so that the RBs of the corresponding CSI RS resource do not overlap with the UL SB RBs, as exemplified in “Option 2-3 A2” of FIG. 11. In this example, the offset RBs is either indicated within the CSI configuration message or determined by the UE. In an example (“Scheme #3), a combination of Scheme #1 and Scheme #2 is implemented. In some implementations, the UE is indicated with an index to the scheme used to overcome or to resolve overlapped RBs.

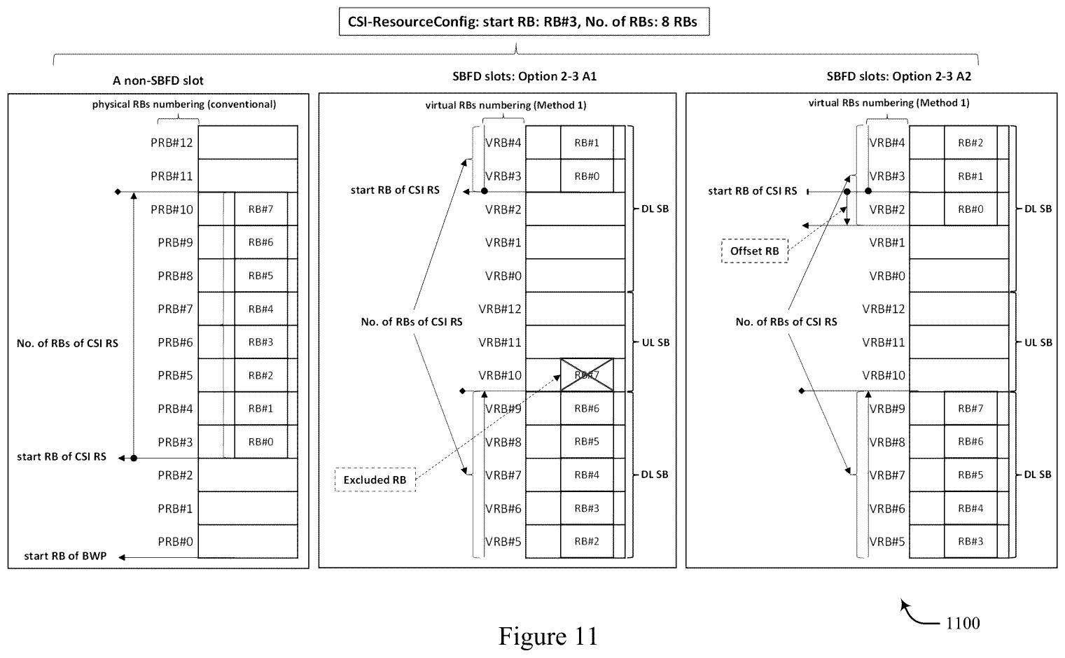

FIG. 12 illustrates an example 1200 of CSI-RS resource FDRA determination and mapping using two virtual RBS numbering methods of a BWP/slot RBs, in accordance with aspects of the present disclosure. For instance, a UE receives, from its serving network node (e.g., a serving gNB), a CSI resource configuration message including one or more of CSI-RS resource settings. In the illustrated example, one or more of the CSI RS resource-settings are applicable (or intended) for non-SBFD time resources (symbols/slots) and one or more of CSI-RS resource settings are applicable (or intended) for SBFD time resources (symbols/slots).

In some implementations, if a UE configured with SBFD symbols occupying two non-contiguous DL SBs in a BWP occupying a sequence of SBFD symbols (e.g., SBFD Case 0 in FIG. 3), and the UE is further configured with receiving an NZP CSI-RS resource for channel measurement, a CSI-RS resource mapping configuration corresponding to the NZP CSI-RS resource is expected to be configured with two CSI frequency occupation parameter sets (e.g., the NZP CSI-RS resource includes two parts). For example, each CSI frequency occupation parameter set (or part) includes a start RB location indicator and a length of RBs indicator. In this example, a first of the two CSI frequency occupation parameter sets (a first part) corresponds to a first of the two non-contiguous DL SBs in the BWP, and a second of the two CSI frequency occupation parameter sets (a second part) corresponds to a second of the two non-contiguous DL SBs in the BWP. In alternative or additional implementations, a second of the two CSI frequency occupation parameter sets (a second part) is indicated with an offset RBs to a first of the two CSI frequency occupation parameter sets (a first part). It is noted that, in some examples, the second of the two CSI frequency occupation parameter sets is optionally configured, based on an existence of two non-contiguous DL SBs in the BWP.

Note that even though the examples shown in the figures are for SBFD Case 0 exemplified in FIG. 3, the above methods can be applied similarly for other cases such as those exemplified in FIG. 3.

Aspects of the present disclosure also include techniques for an enhanced CSI reporting framework for SBFD scenarios, where the CSI reporting framework corresponds to a first set of DL slots (e.g., DL-only non-SBFD slots in FIG. 2) and a second set of SBFD slots (e.g., SBFD slots/symbols) including a set of SBs, where a subset of the set of SBs are DL SBs. A few example implementations are described below. According to a possible implementations, a combination of one or more of the implementations below is possible as well.

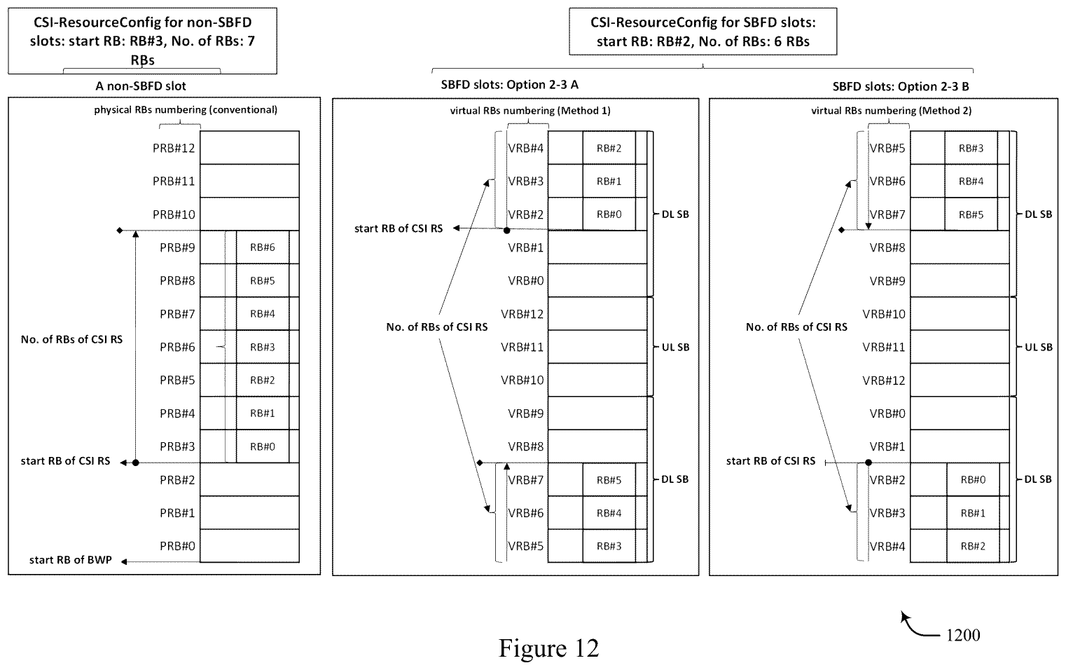

FIG. 13 illustrates an example 1300 of FDRA for SBFD with PMI/CQI mapping to different slots/SBFD sub-bands, in accordance with aspects of the present disclosure. In examples (e.g., K PMI/CQI for K SB groups), a plurality of PMI values are configured to be reported in a CSI report, where a number of the CQI values is equal to a number of the plurality of PMI values. In a first example, a BWP including a set of flexible slots, where the set of flexible slots include an UL SB group that is confined within up to two DL SB groups is expected to be associated with up to three PMI values, a first PMI value is associated with a first DL SB group, a second PMI value is associated with the UL SB group corresponding to a set of DL slots, and a third PMI value, if applicable, is associated with a second DL SB group. In a second example, a PMI value is one-to-one mapped to a CQI value. In a third example, each of the PMI value and the CQI value per SB group follows legacy design, e.g., each of the PMI values and the CQI values is configured with either a wideband format or a sub-band format. Advantageously, the first implementation of FIG. 13 enables a separate configuration per contiguous band and allows reusing legacy PMI/CQI per contiguous band. In some scenarios however, a different implementation may be more suitable to mitigate or reduce potentially unnecessary overhead and/or reporting complexity due to purely DL sub-bands being reported over two PMIs and two CQIs, for example.

FIG. 14 illustrates an example 1400 of FDRA for SBFD with PMI/CQI mapping to different slots/SBFD sub-bands, in accordance with aspects of the present disclosure. In a second implementation (e.g., K PMIs for K SB groups, 2 CQIs for X,D slot groups, etc.), as exemplified by FIG. 14, a plurality of PMI values are configured to be reported in a CSI report. For instance, a number of CQI values is equal to two. In a first example, a BWP includes a set of flexible slots, and the set of flexible slots include an UL SB group that is confined within up to two DL SB groups that is expected to be associated with up to three PMI values. A first PMI value is associated with a first DL SB group, a second PMI value is associated with the UL SB group corresponding to a set of DL slots, and a third PMI value (if applicable) is associated with a second DL SB group. In a second example, a first of the two CQI values is associated with the set of DL slots, and a second of the two CQI values is associated with DL SB groups of the set of flexible slots. Advantageously, the second implementation of FIG. 14 enables a separate configuration per contiguous band and thus allows reusing legacy PMI/CQI per condition band while being associated with less CQI overhead as compared with the first implementation of FIG. 13. However, in some scenarios, the CQI SBs according to sub-band format may be non-contiguous.

FIG. 15 illustrates an example 1500 of FDRA for SBFD with PMI/CQI mapping to different slots/SBFD sub-bands, in accordance with aspects of the present disclosure. In a third implementation (e.g., First PMI/CQI for purely DL SB groups, Second PMI/CQI for flexible SB groups, etc.), as exemplified by FIG. 15, two PMI values are configured to be reported in a CSI report. In a first example, a first of the two PMI values is associated with the DL SB groups of both the set of DL slots and the set of flexible slots, and a second of the two PMI values is associated with the UL SB group corresponding to a set of DL slots. In a second example, a PMI value is one-to-one mapped to a CQI value. Advantageously, the third implementation of FIG. 15 may enable confining overhead since purely DL sub-bands are reported over the same PMI and the same CQI. On the other hand, in some scenarios with this implementation, the RB indices used in CSI reporting may be non-contiguous (e.g., there may be additional mapping from the contiguous SB mapping used in legacy codebooks to non-contiguous SB mapping for SBFD. Further, in some scenarios (e.g., Type II CB), Frequency compression may not be applicable.

FIG. 16 illustrates an example 1600 of FDRA for SBFD with PMI/CQI mapping to different slots/SBFD sub-bands, in accordance with aspects of the present disclosure. In a fourth implementation (e.g., Common PMI for all SB/slot groups, 2 CQIs for X,D slot groups), as exemplified by FIG. 16, one PMI value is configured to be reported in a CSI report. In a first example, the PMI value is associated with DL SBs and DL slots over the BWP. In a second example, an UL SB group size is an integer multiple of a PMI SB size. In a third example, two CQI are configured to be reported in the CSI report, a first of the two CQI values is associated with the set of DL slots, and a second of the two CQI values is associated with the set of flexible slots. In a fourth example, a reference coefficient in the PMI value is associated with a SB in the DL SBs. Advantageously, with the fourth implementation, the PMI may be confined (frequency compression is not a problem. In some scenarios however, the PMI may have a reference SB (e.g., a SB in which the precoding coefficient is 1), and thus additional configuration may be used to ensure this reference SB is not a flexible SB.

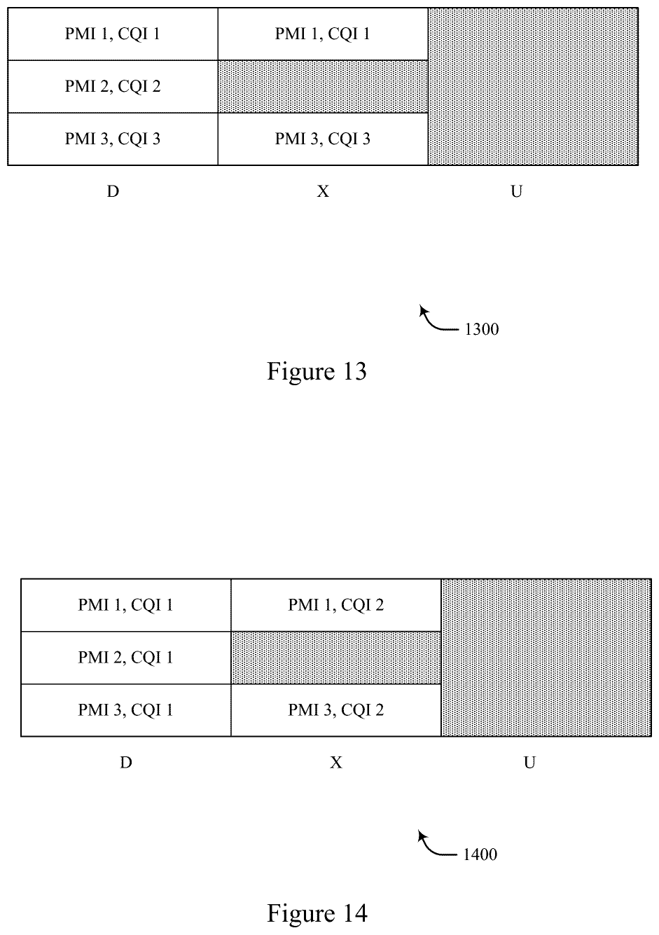

FIGS. 17 and 18 illustrate examples of two alternative designs 1700, 1800 for CSI frameworks, in accordance with aspects of the present disclosure. In a fifth implementation (e.g., CSI reporting setting includes K sub-configs and K CSI (sub-)reports), as exemplified by FIGS. 17 and 18, the CSI reporting configuration associated with SBFD includes two CSI reporting sub-configurations. In a first example, a first of the two CSI reporting sub-configurations corresponds to the set of DL slots and is associated with a first of two CSI reports, and a second of the two CSI reporting sub-configurations corresponds to the DL SB groups of the set of flexible slots and is associated with a second of the two CSI reports. Note that the second of the two CSI reports may include two PMI values corresponding to two non-contiguous DL SB groups. A CSI report priority, with respect to a mapping order of CSI reports, of the first of the two CSI reports is higher than the second of the two CSI reports, e.g., the first of the two CSI reports is reported prior to the second of the two CSI reports. In a second example, a first of the two CSI reporting sub-configurations corresponds to the set of DL slots and is associated with a first of two CSI sub-reports of a CSI report, and a second of the two CSI reporting sub-configurations corresponds to the DL SB groups of the set of flexible slots and is associated with a second of the two CSI sub-reports of the CSI report. Note that the second of the two CSI sub-reports may include two PMI values corresponding to two non-contiguous DL SB groups. A CSI sub-report priority, with respect to a mapping order of CSI sub-reports, of the first of the two CSI sub-reports is higher than the second of the two CSI sub-reports, e.g., the first of the two CSI sub-reports is reported prior to the second of the two CSI sub-reports. In some examples, an identification of the SBFD configuration is included in the second of the two CSI reporting sub-configurations.

In a sixth implementation (e.g., SBFD config ID reported in CSI reporting config), an indication of the UL SB groups of the set of flexible slots is identified within the CSI reporting configuration. In a first example, the indication is in a form of an SBFD configuration ID reported in the CSI reporting setting. In a second example, the CSI report is based on both a CSI reporting configuration and an SBFD configuration. In a third example, the UE is configured with a CSI reporting configuration associated with SBFD transmission, and where a bitmap identifying the UL SB group is signaled to the UE in a later configuration message, the later configuration message corresponds to a MAC-CE signal or a DCI parameter.

In a seventh implementation (e.g., common RI value for SBFD symbols/sub-bands and non-SBFD symbols/sub-bands), a common RI value is applied to CSI reporting corresponding to the DL slot groups and the DL symbols of the flexible slot groups. The common RI value corresponds to the PMI values and CQI values of either the DL slot groups and the flexible slot groups.

In an eighth implementation (e.g., mapping order of CSI fields for SBFD-based CSI report), a mapping order of the CSI fields corresponding to the CSI report quantities associated with DL slot groups and DL symbols of flexible slot groups is identified. In a first example, the CSI report includes two parts: a CSI report Part 1 and a CSI report Part 2. The CSI report Part 2 may be further divided into a plurality of groups. A first group of the plurality of groups may be associated with wideband CSI, and a remainder of groups of the plurality of groups may be associated with sub-band CSI. In a second example, the CSI report Part 1 further includes two partitions, sub-reports, or a combination thereof, and where each partition includes a CQI value. For instance, the CQI value associated with the DL slot groups is reported in the first of the two partitions, and the CQI value associated with the DL symbols of the flexible slot groups is reported in the second of the two partitions. An RI value associated with either the DL slot groups or the DL symbols of the flexible slot groups is reported in the first partition of the CSI report Part 1. In a third example, the CSI report Part 2 includes two or more groups, where a first of the two or more groups includes PMI associated with higher priority coefficient indices, e.g., even sub-band indices, and a second of the two or more groups includes PMI associated with lower priority coefficient indices, e.g., odd sub-band indices. In a fourth example, the CSI report Part 2 includes two or more groups, where a first of the two or more groups includes PMI associated with SBFD sub-bands and a second of the two or more groups includes PMI associated with non-SBFD sub-bands.

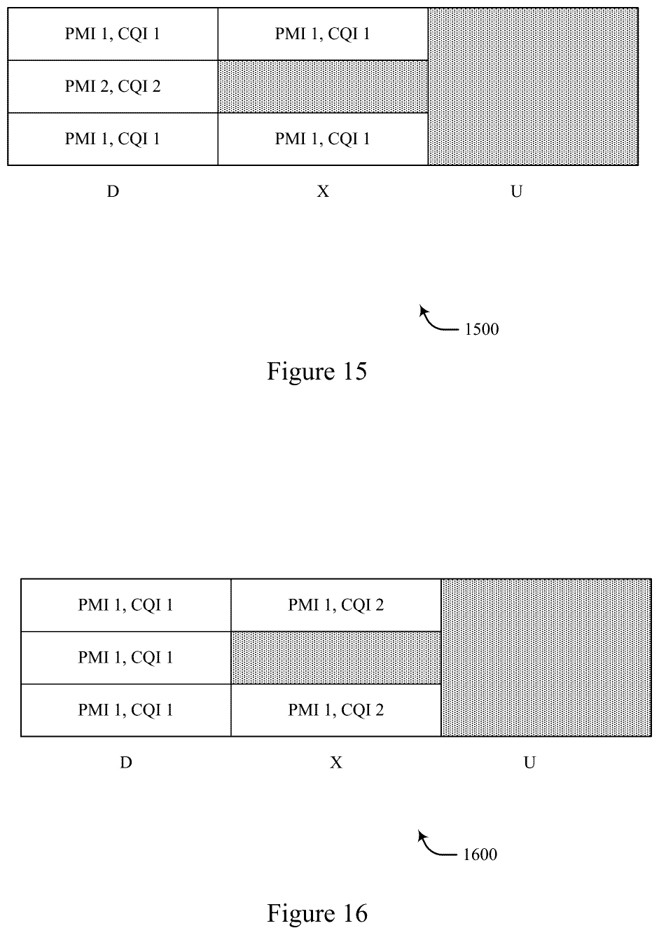

FIG. 19 illustrates an example of a UE 1900 in accordance with aspects of the present disclosure. The UE 1900 may include a processor 1902, a memory 1904, a controller 1906, and a transceiver 1908. The processor 1902, the memory 1904, the controller 1906, or the transceiver 1908, or various combinations thereof or various components thereof may be examples of means for performing various aspects of the present disclosure as described herein. These components may be coupled (e.g., operatively, communicatively, functionally, electronically, electrically) via one or more interfaces.

The processor 1902, the memory 1904, the controller 1906, or the transceiver 1908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1902 may include an intelligent hardware device (e.g., a general-purpose processor, a DSP, a CPU, an ASIC, an FPGA, or any combination thereof). In some implementations, the processor 1902 may be configured to operate the memory 1904. In some other implementations, the memory 1904 may be integrated into the processor 1902. The processor 1902 may be configured to execute computer-readable instructions stored in the memory 1904 to cause the UE 1900 to perform various functions of the present disclosure.

The memory 1904 may include volatile or non-volatile memory. The memory 1904 may store computer-readable, computer-executable code including instructions when executed by the processor 1902 cause the UE 1900 to perform various functions described herein. The code may be stored in a non-transitory computer-readable medium such as the memory 1904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1902 and the memory 1904 coupled with the processor 1902 may be configured to cause the UE 1900 to perform one or more of the functions described herein (e.g., executing, by the processor 1902, instructions stored in the memory 1904). For example, the processor 1902 may support wireless communication at the UE 1900 in accordance with examples as disclosed herein. The UE 1900 may be configured to or operable to support a means for receiving a configuration message for CSI reporting, the configuration message indicating one or more configuration parameter sets for different sets of slots in a BWP; and transmitting, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

Additionally, the UE 1900 may be configured to support any one or combination of where the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups. The configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Additionally, or alternatively, the UE 1900 may support at least one memory (e.g., the memory 1904) and at least one processor (e.g., the processor 1902) coupled with the at least one memory and configured to cause the UE to: receive a configuration message for CSI reporting, the configuration message indicating one or more configuration parameter sets for different sets of slots in a BWP; and transmit, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission

Additionally, the UE 1900 may be configured to support any one or combination of where the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

Additionally, the UE 1900 may be configured to support any one or combination of where the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PM) value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

In some implementations, the processor 1902 and the memory 1904 coupled with the processor 1902 may be configured to cause the UE 1900 to perform one or more of the functions described herein (e.g., executing, by the processor 1902, instructions stored in the memory 1904). For example, the processor 1902 may support wireless communication at the UE 1900 in accordance with examples as disclosed herein. The UE 1900 may be configured to or operable to support a means for receiving a configuration message for CSI-RS resource settings, the configuration message indicating one or more CSI-RS resources, where at least one CSI-RS resource is associated with two different time resource types; and transmitting, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Additionally, the UE 1900 may be configured to support any one or combination of where the first CSI-RS resource setting includes a first FDRA physical-to-virtual mapping and the second CSI-RS resource setting includes a second FDRA physical-to-virtual mapping. Means for applying the first FDRA physical-to-virtual mapping during the first time resource type and the second FDRA physical-to-virtual mapping during the second time resource type. Each of the one or more CSI-RS resources is associated with one or more time resource index sets. Means for determining a FDRA mapping for a CSI-RS resource based on a physical-to-virtual RBs mapping method indicated by the configuration message. A time resource type incudes a SBFD time resource type or a non-SBFD time resource type. The configuration message indicates one or more of the SBFD time resource type or the non-SBFD time resource type. Means for receiving another configuration message indicating one or more of the SBFD time resource type or the non-SBFD time resource type. A FDRA of a CSI-RS resource is indicated via at least one of: a start RB or a number of RBs.

Additionally, the UE 1900 may be configured to support any one or combination of where the configuration message further indicates a physical-to-virtual RBs mapping configuration. The physical-to-virtual RBs mapping configuration indicates at least one of: a method index, a start RB, or a total number of RBs. Means for determining at least one of the start RB or the total number of RBs based on at least one of: a BWP configuration message or a SBFD time-frequency resource configuration message. Means for mapping a physical RBs group to a virtual RBs group based on the physical-to-virtual RBs mapping configuration. The configuration message indicates a grouping level for the mapping of the physical RBs group to the virtual RBs group. Means for performing an RB-overlapping-handling scheme indicated by the configuration message in response to determining that one or more RBs of a CSI-RS resource overlap one or more RBs of a sub-band outside one or more DL sub-bands. Means for excluding the one or more RBs overlapping the one or more RBs of a sub-band outside one or more DL sub-bands; or applying an offset to a start RB parameter of the CSI-RS resource. The configuration message indicates the offset for the start RB parameter of the CSI-RS resource. The one or more CSI-RS resources includes a first set of CSI-RS resources associated with the first time resource type or a first set of time resource indexes, and a second set of CSI-RS resources associated with the second time resource type or a second set of time resource indexes. Means for determining a first FDRA physical-to-virtual mapping for a CSI-RS resource of the first set of CSI-RS resources or a first index of the first set of time resource indexes; and determining a second FDRA physical-to-virtual mapping for a CSI-RS resource of the second set of CSI-RS resources or a second index of the second set of time resource indexes. A CSI-RS resource associated with a time resource type or time resource index occupying two non-contiguous DL sub-bands (SBs) in a BWP is configured with two CSI resource frequency occupation parameter sets. A CSI resource frequency occupation parameter set includes a start RB location indicator and a number of RBs indicator. A first of the two CSI resource frequency occupation parameter sets is indicated by an offset RBs to the second of the two CSI resource frequency occupation parameter sets. A first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

Additionally, or alternatively, the UE 1900 may support at least one memory (e.g., the memory 1904) and at least one processor (e.g., the processor 1902) coupled with the at least one memory and configured to cause the UE to: receive a configuration message for CSI-RS resource settings, the configuration message indicating one or more CSI-RS resources, where at least one CSI-RS resource is associated with two different time resource types; and transmit, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Additionally, the UE 1900 may be configured to support any one or combination of where the first CSI-RS resource setting includes a first FDRA physical-to-virtual mapping and the second CSI-RS resource setting includes a second FDRA physical-to-virtual mapping. The UE to apply the first FDRA physical-to-virtual mapping during the first time resource type and the second FDRA physical-to-virtual mapping during the second time resource type. Each of the one or more CSI-RS resources is associated with one or more time resource index sets. The UE to determine a FDRA mapping for a CSI-RS resource based on a physical-to-virtual RBs mapping method indicated by the configuration message. A time resource type incudes a SBFD time resource type or a non-SBFD time resource type. The configuration message indicates one or more of the SBFD time resource type or the non-SBFD time resource type. The UE to receive another configuration message indicating one or more of the SBFD time resource type or the non-SBFD time resource type. A FDRA of a CSI-RS resource is indicated via at least one of: a start RB or a number of RBs.

Additionally, the UE 1900 may be configured to support any one or combination of where the configuration message further indicates a physical-to-virtual RBs mapping configuration. The physical-to-virtual RBs mapping configuration indicates at least one of: a method index, a start RB, or a total number of RBs. The UE to determine at least one of the start RB or the total number of RBs based on at least one of: a BWP configuration message or a SBFD time-frequency resource configuration message. The UE to map a physical RBs group to a virtual RBs group based on the physical-to-virtual RBs mapping configuration. The configuration message indicates a grouping level for the mapping of the physical RBs group to the virtual RBs group. The UE to perform an RB-overlapping-handling scheme indicated by the configuration message in response to determining that one or more RBs of a CSI-RS resource overlap one or more RBs of a sub-band outside one or more DL sub-bands. The UE to exclude the one or more RBs overlapping the one or more RBs of a sub-band outside one or more DL sub-bands; or applying an offset to a start RB parameter of the CSI-RS resource.

Additionally, the UE 1900 may be configured to support any one or combination of where the one or more CSI-RS resources includes a first set of CSI-RS resources associated with the first time resource type or a first set of time resource indexes, and a second set of CSI-RS resources associated with the second time resource type or a second set of time resource indexes. The UE to determine a first FDRA physical-to-virtual mapping for a CSI-RS resource of the first set of CSI-RS resources or a first index of the first set of time resource indexes; and determine a second FDRA physical-to-virtual mapping for a CSI-RS resource of the second set of CSI-RS resources or a second index of the second set of time resource indexes. A CSI-RS resource associated with a time resource type or time resource index occupying two non-contiguous DL sub-bands (SBs) in a BWP is configured with two CSI resource frequency occupation parameter sets. A CSI resource frequency occupation parameter set includes a start RB location indicator and a number of RBs indicator. A first of the two CSI resource frequency occupation parameter sets is indicated by an offset RBs to the second of the two CSI resource frequency occupation parameter sets. A first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

The controller 1906 may manage input and output signals for the UE 1900. The controller 1906 may also manage peripherals not integrated into the UE 1900. In some implementations, the controller 1906 may utilize an operating system such as iOS®, ANDROID®, WINDOWS®, or other operating systems. In some implementations, the controller 1906 may be implemented as part of the processor 1902.

In some implementations, the UE 1900 may include at least one transceiver 1908. In some other implementations, the UE 1900 may have more than one transceiver 1908. The transceiver 1908 may represent a wireless transceiver. The transceiver 1908 may include one or more receiver chains 1910, one or more transmitter chains 1912, or a combination thereof.

A receiver chain 1910 may be configured to receive signals (e.g., control information, data, packets) over a wireless medium. For example, the receiver chain 1910 may include one or more antennas to receive a signal over the air or wireless medium. The receiver chain 1910 may include at least one amplifier (e.g., a low-noise amplifier (LNA)) configured to amplify the received signal. The receiver chain 1910 may include at least one demodulator configured to demodulate the receive signal and obtain the transmitted data by reversing the modulation technique applied during transmission of the signal. The receiver chain 1910 may include at least one decoder for decoding the demodulated signal to receive the transmitted data.

A transmitter chain 1912 may be configured to generate and transmit signals (e.g., control information, data, packets). The transmitter chain 1912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1912 may also include at least one power amplifier configured to amplify the modulated signal to an appropriate power level suitable for transmission over the wireless medium. The transmitter chain 1912 may also include one or more antennas for transmitting the amplified signal into the air or wireless medium.

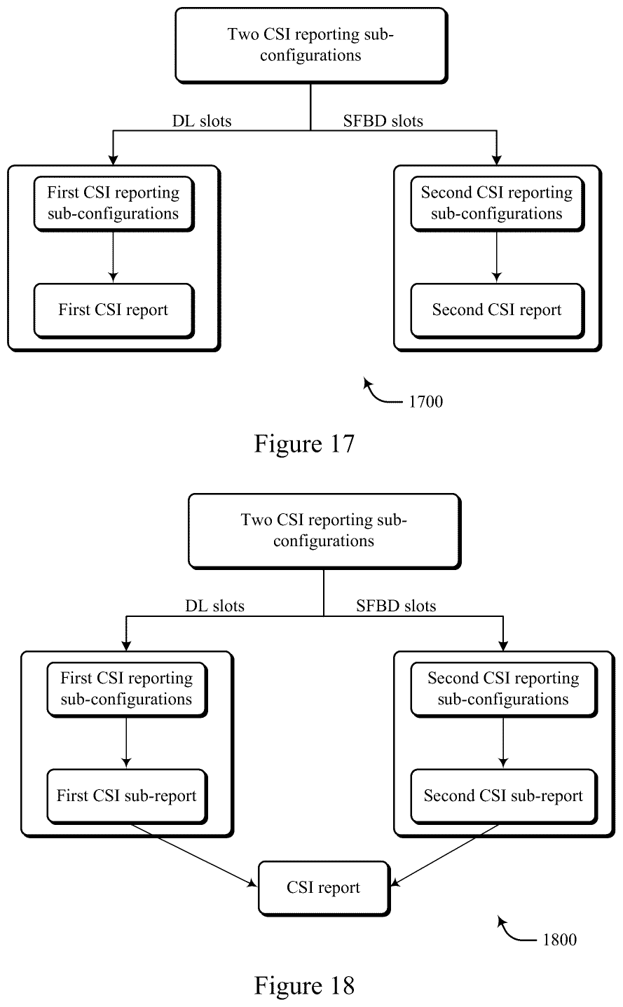

FIG. 20 illustrates an example of a processor 2000 in accordance with aspects of the present disclosure. The processor 2000 may be an example of a processor configured to perform various operations in accordance with examples as described herein. The processor 2000 may include a controller 2002 configured to perform various operations in accordance with examples as described herein. The processor 2000 may optionally include at least one memory 2004, which may be, for example, an L1/L2/L3 cache. Additionally, or alternatively, the processor 2000 may optionally include one or more arithmetic-logic units (ALUs) 2006. One or more of these components may be in electronic communication or otherwise coupled (e.g., operatively, communicatively, functionally, electronically, electrically) via one or more interfaces (e.g., buses).

The processor 2000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2002 may be configured to manage and coordinate various operations (e.g., signaling, receiving, obtaining, retrieving, transmitting, outputting, forwarding, storing, determining, identifying, accessing, writing, reading) of the processor 2000 to cause the processor 2000 to support various operations in accordance with examples as described herein. For example, the controller 2002 may operate as a control unit of the processor 2000, generating control signals that manage the operation of various components of the processor 2000. These control signals include enabling or disabling functional units, selecting data paths, initiating memory access, and coordinating timing of operations.

The controller 2002 may be configured to fetch (e.g., obtain, retrieve, receive) instructions from the memory 2004 and determine subsequent instruction(s) to be executed to cause the processor 2000 to support various operations in accordance with examples as described herein. The controller 2002 may be configured to track memory addresses of instructions associated with the memory 2004. The controller 2002 may be configured to decode instructions to determine the operation to be performed and the operands involved. For example, the controller 2002 may be configured to interpret the instruction and determine control signals to be output to other components of the processor 2000 to cause the processor 2000 to support various operations in accordance with examples as described herein. Additionally, or alternatively, the controller 2002 may be configured to manage flow of data within the processor 2000. The controller 2002 may be configured to control transfer of data between registers, ALUs 2006, and other functional units of the processor 2000.

The memory 2004 may include one or more caches (e.g., memory local to or included in the processor 2000 or other memory, such as RAM, ROM, DRAM, SDRAM, SRAM, MRAM, flash memory, etc. In some implementations, the memory 2004 may reside within or on a processor chipset (e.g., local to the processor 2000). In some other implementations, the memory 2004 may reside external to the processor chipset (e.g., remote to the processor 2000).

The memory 2004 may store computer-readable, computer-executable code including instructions that, when executed by the processor 2000, cause the processor 2000 to perform various functions described herein. The code may be stored in a non-transitory computer-readable medium such as system memory or another type of memory. The controller 2002 and/or the processor 2000 may be configured to execute computer-readable instructions stored in the memory 2004 to cause the processor 2000 to perform various functions. For example, the processor 2000 and/or the controller 2002 may be coupled with or to the memory 2004, the processor 2000, and the controller 2002, and may be configured to perform various functions described herein. In some examples, the processor 2000 may include multiple processors and the memory 2004 may include multiple memories. One or more of the multiple processors may be coupled with one or more of the multiple memories, which may, individually or collectively, be configured to perform various functions herein.

The one or more ALUs 2006 may be configured to support various operations in accordance with examples as described herein. In some implementations, the one or more ALUs 2006 may reside within or on a processor chipset (e.g., the processor 2000). In some other implementations, the one or more ALUs 2006 may reside external to the processor chipset (e.g., the processor 2000). One or more ALUs 2006 may perform one or more computations such as addition, subtraction, multiplication, and division on data. For example, one or more ALUs 2006 may receive input operands and an operation code, which determines an operation to be executed. One or more ALUs 2006 may be configured with a variety of logical and arithmetic circuits, including adders, subtractors, shifters, and logic gates, to process and manipulate the data according to the operation. Additionally, or alternatively, the one or more ALUs 2006 may support logical operations such as AND, OR, exclusive-OR (XOR), not-OR (NOR), and not-AND (NAND), enabling the one or more ALUs 2006 to handle conditional operations, comparisons, and bitwise operations.

The processor 2000 may support wireless communication in accordance with examples as disclosed herein. The processor 2000 may be configured to or operable to support at least one controller (e.g., the controller 2002) coupled with at least one memory (e.g., the memory 2004) and configured to cause the processor to: receive a configuration message for CSI reporting, the configuration message indicating one or more configuration parameter sets for different sets of slots in a BWP; and transmit, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission

Additionally, the processor 2000 may be configured to or operable to support any one or combination of where the at least one controller is configured to cause the processor to the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

Additionally, the processor 2000 may be configured to or operable to support any one or combination of where the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

The processor 2000 may support wireless communication in accordance with examples as disclosed herein. The processor 2000 may be configured to or operable to support at least one controller (e.g., the controller 2002) coupled with at least one memory (e.g., the memory 2004) and configured to cause the processor to: receive a configuration message for CSI-RS resource settings, the configuration message indicating one or more CSI-RS resources, where at least one CSI-RS resource is associated with two different time resource types; and transmit, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Additionally, the processor 2000 may be configured to or operable to support any one or combination of where the at least one controller is configured to cause the processor to the first CSI-RS resource setting includes a first FDRA physical-to-virtual mapping and the second CSI-RS resource setting includes a second FDRA physical-to-virtual mapping. The at least one controller is configured to cause the processor to apply the first FDRA physical-to-virtual mapping during the first time resource type and the second FDRA physical-to-virtual mapping during the second time resource type. Each of the one or more CSI-RS resources is associated with one or more time resource index sets. The at least one controller is configured to cause the processor to determine a FDRA mapping for a CSI-RS resource based on a physical-to-virtual RBs mapping method indicated by the configuration message. A time resource type incudes a SBFD time resource type or a non-SBFD time resource type. The configuration message indicates one or more of the SBFD time resource type or the non-SBFD time resource type. The at least one controller is configured to cause the processor to receive another configuration message indicating one or more of the SBFD time resource type or the non-SBFD time resource type. A FDRA of a CSI-RS resource is indicated via at least one of: a start RB or a number of RBs.

Additionally, the processor 2000 may be configured to or operable to support any one or combination of where the configuration message further indicates a physical-to-virtual RBs mapping configuration. The physical-to-virtual RBs mapping configuration indicates at least one of: a method index, a start RB, or a total number of RBs. The at least one controller is configured to cause the processor to determine at least one of the start RB or the total number of RBs based on at least one of: a BWP configuration message or a SBFD time-frequency resource configuration message. The at least one controller is configured to cause the processor to map a physical RBs group to a virtual RBs group based on the physical-to-virtual RBs mapping configuration. The configuration message indicates a grouping level for the mapping of the physical RBs group to the virtual RBs group. The at least one controller is configured to cause the processor to perform an RB-overlapping-handling scheme indicated by the configuration message in response to determining that one or more RBs of a CSI-RS resource overlap one or more RBs of a sub-band outside one or more DL sub-bands. The at least one controller is configured to cause the processor to exclude the one or more RBs overlapping the one or more RBs of a sub-band outside one or more DL sub-bands; or applying an offset to a start RB parameter of the CSI-RS resource.

Additionally, the processor 2000 may be configured to or operable to support any one or combination of where the one or more CSI-RS resources includes a first set of CSI-RS resources associated with the first time resource type or a first set of time resource indexes, and a second set of CSI-RS resources associated with the second time resource type or a second set of time resource indexes. The at least one controller is configured to cause the processor to determine a first FDRA physical-to-virtual mapping for a CSI-RS resource of the first set of CSI-RS resources or a first index of the first set of time resource indexes; and determine a second FDRA physical-to-virtual mapping for a CSI-RS resource of the second set of CSI-RS resources or a second index of the second set of time resource indexes. A CSI-RS resource associated with a time resource type or time resource index occupying two non-contiguous DL sub-bands (SBs) in a BWP is configured with two CSI resource frequency occupation parameter sets. A CSI resource frequency occupation parameter set includes a start RB location indicator and a number of RBs indicator. A first of the two CSI resource frequency occupation parameter sets is indicated by an offset RBs to the second of the two CSI resource frequency occupation parameter sets. A first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

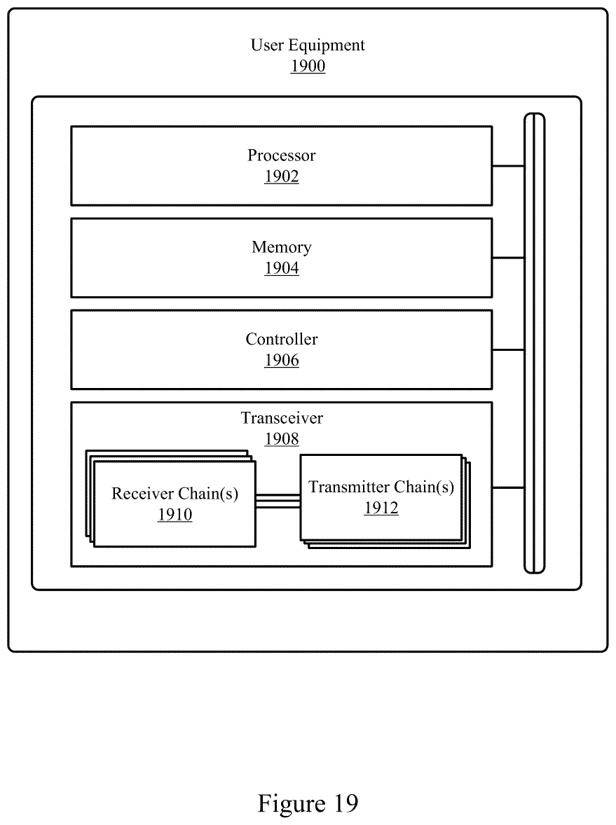

FIG. 21 illustrates an example of a NE 2100 in accordance with aspects of the present disclosure. The NE 2100 may include a processor 2102, a memory 2104, a controller 2106, and a transceiver 2108. The processor 2102, the memory 2104, the controller 2106, or the transceiver 2108, or various combinations thereof or various components thereof may be examples of means for performing various aspects of the present disclosure as described herein. These components may be coupled (e.g., operatively, communicatively, functionally, electronically, electrically) via one or more interfaces.

The processor 2102, the memory 2104, the controller 2106, or the transceiver 2108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2102 may include an intelligent hardware device (e.g., a general-purpose processor, a DSP, a CPU, an ASIC, an FPGA, or any combination thereof). In some implementations, the processor 2102 may be configured to operate the memory 2104. In some other implementations, the memory 2104 may be integrated into the processor 2102. The processor 2102 may be configured to execute computer-readable instructions stored in the memory 2104 to cause the NE 2100 to perform various functions of the present disclosure.

The memory 2104 may include volatile or non-volatile memory. The memory 2104 may store computer-readable, computer-executable code including instructions when executed by the processor 2102 cause the NE 2100 to perform various functions described herein. The code may be stored in a non-transitory computer-readable medium such as the memory 2104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2102 and the memory 2104 coupled with the processor 2102 may be configured to cause the NE 2100 to perform one or more of the functions described herein (e.g., executing, by the processor 2102, instructions stored in the memory 2104). For example, the processor 2102 may support wireless communication at the NE 2100 in accordance with examples as disclosed herein. The NE 2100 may be configured to or operable to support a means for transmitting a configuration message for CSI reporting, the configuration message indicating one or more configuration parameter sets for different sets of slots in a BWP; and receiving, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

Additionally, the NE 2100 may be configured to or operable to support any one or combination of the method further including the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

Additionally, the NE 2100 may be configured to or operable to support any one or combination of where the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

Additionally, or alternatively, the NE 2100 may support at least one memory (e.g., the memory 2104) and at least one processor (e.g., the processor 2102) coupled with the at least one memory and configured to cause the NE to: transmit a configuration message for CSI reporting, the configuration message indicating one or more configuration parameter sets for different sets of slots in a BWP; and receive, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission.

Additionally, the NE 2100 may be configured to support any one or combination of where the at least one processor is configured to cause the NE to the first set of slots includes at least one sub-band group associated with UL transmission and at least one other sub-band group associated with DL transmission. The at least one CSI report indicates a second CSI report quantity including a first value for the at least one sub-band group and a second value for the at least one other sub-band group. The second CSI report quantity corresponds to a CQI, the at least one CSI report indicating a first CQI value associated with the at least one sub-band group and a second CQI value associated with the at least one other sub-band group. The second CSI report quantity corresponds to a PMI, the at least one CSI report indicating a first PMI value associated with the at least one sub-band group and a second PMI value associated with the at least one other sub-band group. The SBFD symbols are associated with three sub-band groups corresponding to two non-contiguous DL sub-bands and one UL sub-band, the at least one CSI report indicating a distinct PMI value for each of the three sub-band groups.

Additionally, the NE 2100 may be configured to or operable to support any one or combination of where the configuration message includes two CSI reporting sub-configurations corresponding to two of: the SBFD symbols, the non-SBFD symbols, the at least one sub-band group, or the at least one other sub-band group. The CSI reporting sub-configurations is associated with at least one of a CSI sub-report or a CSI report. The first CSI report quantity corresponds to a CQI, the at least one CSI report indicating a first CQI value for the first set of slots and a second CQI value for the second set of slots. The SBFD symbols are associated with two sub-band groups corresponding to one DL sub-band and one UL sub-band, the at least one CSI report indicating a distinct PMI value for each of the two sub-band groups. The at least one CSI report indicates a common CQI value for the SBFD symbols and the non-SBFD symbols. The at least one CSI report indicates a common PMI value for the SBFD symbols and the non-SBFD symbols. The at least one CSI report indicates a common RI value for the SBFD symbols and the non-SBFD symbols. The at least one CSI report includes a first part and a second part, each part associated with one or more CSI parameters, and the second part including one or more groups. A first group of the one or more groups includes a first set of PMI parameters associated with the SBFD symbols, and a second group of the one or more groups includes a second set of PMI parameters associated with the non-SBFD symbols. The configuration message includes an identification of a configuration message associated with an SBFD symbols-related configuration.

In some implementations, the processor 2102 and the memory 2104 coupled with the processor 2102 may be configured to cause the NE 2100 to perform one or more of the functions described herein (e.g., executing, by the processor 2102, instructions stored in the memory 2104). For example, the processor 2102 may support wireless communication at the NE 2100 in accordance with examples as disclosed herein. The NE 2100 may be configured to or operable to support a means for transmitting a configuration message for CSI-RS resource settings, the configuration message indicating one or more CSI-RS resources, where at least one CSI-RS resource is associated with two different time resource types; and receiving, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Additionally, the NE 2100 may be configured to or operable to support any one or combination of the method further including the first CSI-RS resource setting includes a first FDRA physical-to-virtual mapping and the second CSI-RS resource setting includes a second FDRA physical-to-virtual mapping. Each of the one or more CSI-RS resources is associated with one or more time resource index sets. a time resource type incudes a SBFD time resource type or a non-SBFD time resource type. The configuration message indicates one or more of the SBFD time resource type or the non-SBFD time resource type. A FDRA of a CSI-RS resource is indicated via at least one of: a start RB or a number of RBs. the configuration message further indicates a physical-to-virtual RBs mapping configuration, the physical-to-virtual RBs mapping configuration indicates at least one of: a method index, a start RB, or a total number of RBs. the one or more CSI-RS resources includes a first set of CSI-RS resources associated with the first time resource type or a first set of time resource indexes, and a second set of CSI-RS resources associated with the second time resource type or a second set of time resource indexes. a CSI-RS resource associated with a time resource type or time resource index occupying two non-contiguous DL sub-bands (SBs) in a BWP is configured with two CSI resource frequency occupation parameter sets. a CSI resource frequency occupation parameter set includes a start RB location indicator and a number of RBs indicator. a first of the two CSI resource frequency occupation parameter sets is indicated by an offset RBs to the second of the two CSI resource frequency occupation parameter sets. a first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

Additionally, or alternatively, the NE 2100 may support at least one memory (e.g., the memory 2104) and at least one processor (e.g., the processor 2102) coupled with the at least one memory and configured to cause the NE to: transmit a configuration message for CSI-RS resource settings, the configuration message indicating one or more CSI-RS resources, where at least one CSI-RS resource is associated with two different time resource types; and receive, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type.

Additionally, the NE 2100 may be configured to support any one or combination of the at least one processor is configured to cause the NE to the first CSI-RS resource setting includes a first FDRA physical-to-virtual mapping and the second CSI-RS resource setting includes a second FDRA physical-to-virtual mapping. Each of the one or more CSI-RS resources is associated with one or more time resource index sets. a time resource type incudes a SBFD time resource type or a non-SBFD time resource type. The configuration message indicates one or more of the SBFD time resource type or the non-SBFD time resource type. A FDRA of a CSI-RS resource is indicated via at least one of: a start RB or a number of RBs. the configuration message further indicates a physical-to-virtual RBs mapping configuration, the physical-to-virtual RBs mapping configuration indicates at least one of: a method index, a start RB, or a total number of RBs. the one or more CSI-RS resources includes a first set of CSI-RS resources associated with the first time resource type or a first set of time resource indexes, and a second set of CSI-RS resources associated with the second time resource type or a second set of time resource indexes. a CSI-RS resource associated with a time resource type or time resource index occupying two non-contiguous DL sub-bands (SBs) in a BWP is configured with two CSI resource frequency occupation parameter sets. a CSI resource frequency occupation parameter set includes a start RB location indicator and a number of RBs indicator. a first of the two CSI resource frequency occupation parameter sets is indicated by an offset RBs to the second of the two CSI resource frequency occupation parameter sets. a first of the two CSI resource frequency occupation parameter sets corresponds to a first of the two non-contiguous DL SBs in the BWP, and the second of the two CSI resource frequency occupation parameter sets corresponds to the second of the two non-contiguous DL SBs in the BWP.

The controller 2106 may manage input and output signals for the NE 2100. The controller 2106 may also manage peripherals not integrated into the NE 2100. In some implementations, the controller 2106 may utilize an operating system such as iOS®, ANDROID®, WINDOWS®, or other operating systems. In some implementations, the controller 2106 may be implemented as part of the processor 2102.

In some implementations, the NE 2100 may include at least one transceiver 2108. In some other implementations, the NE 2100 may have more than one transceiver 2108. The transceiver 2108 may represent a wireless transceiver. The transceiver 2108 may include one or more receiver chains 2110, one or more transmitter chains 2112, or a combination thereof.

A receiver chain 2110 may be configured to receive signals (e.g., control information, data, packets) over a wireless medium. For example, the receiver chain 2110 may include one or more antennas to receive a signal over the air or wireless medium. The receiver chain 2110 may include at least one amplifier (e.g., a low-noise amplifier (LNA)) configured to amplify the received signal. The receiver chain 2110 may include at least one demodulator configured to demodulate the receive signal and obtain the transmitted data by reversing the modulation technique applied during transmission of the signal. The receiver chain 2110 may include at least one decoder for decoding the demodulated signal to receive the transmitted data.

A transmitter chain 2112 may be configured to generate and transmit signals (e.g., control information, data, packets). The transmitter chain 2112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2112 may also include at least one power amplifier configured to amplify the modulated signal to an appropriate power level suitable for transmission over the wireless medium. The transmitter chain 2112 may also include one or more antennas for transmitting the amplified signal into the air or wireless medium.

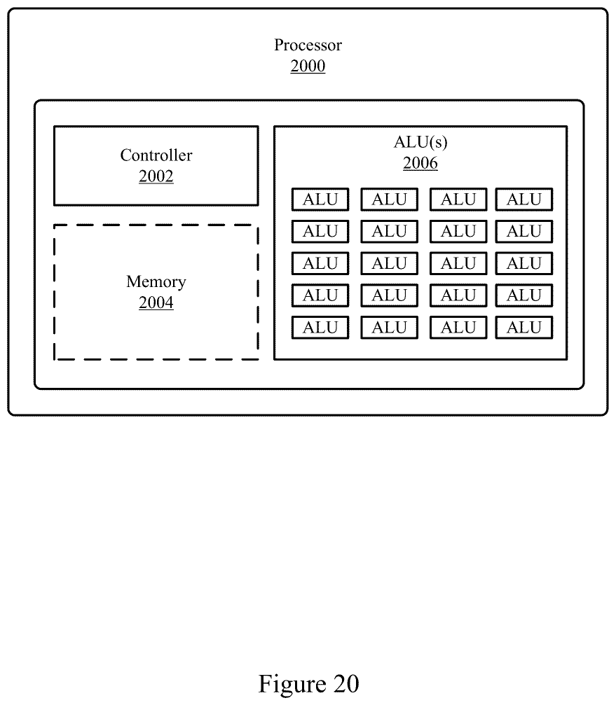

FIG. 22 illustrates a flowchart of a method 2200 in accordance with aspects of the present disclosure. The operations of the method may be implemented by a UE as described herein. In some implementations, the UE may execute a set of instructions to control the function elements of the UE to perform the described functions. Note that the method described herein describes a possible implementation, and that the operations and the steps may be rearranged or otherwise modified and that other implementations are possible.

At 2202, the method may include receiving a configuration message for CSI reporting, the configuration message indicating one or more configuration parameter sets for different sets of slots in a BWP. The operations of 2202 may be performed in accordance with examples as described herein. In some implementations, aspects of the operations of 2202 may be performed by a UE as described with reference to FIG. 19.

At 2204, the method may include transmitting, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission. The operations of 2204 may be performed in accordance with examples as described herein. In some implementations, aspects of the operations of 2204 may be performed by a UE as described with reference to FIG. 19.

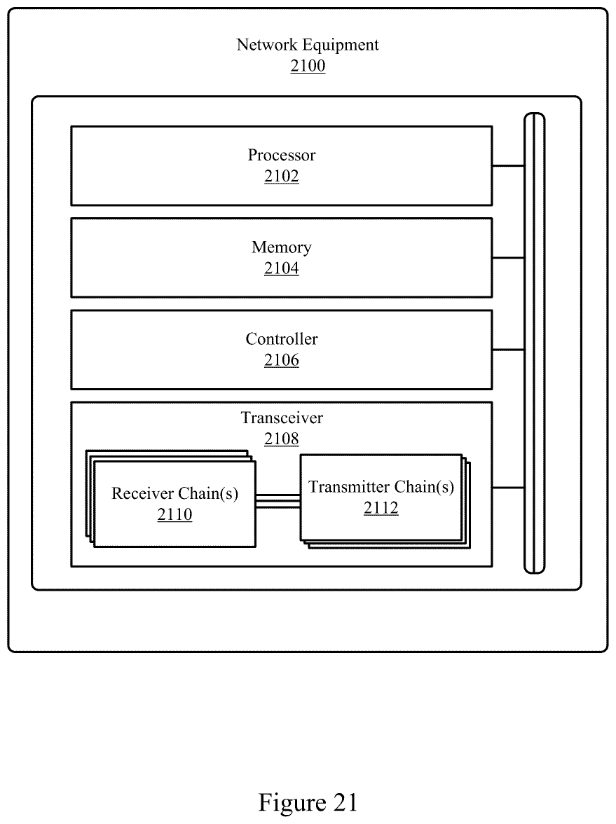

FIG. 23 illustrates a flowchart of a method 2300 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2302, the method may include transmitting a configuration message for CSI reporting, the configuration message indicating one or more configuration parameter sets for different sets of slots in a BWP. The operations of 2302 may be performed in accordance with examples as described herein. In some implementations, aspects of the operations of 2302 may be performed by a NE as described with reference to FIG. 21.

At 2304, the method may include receiving, based at least in part on the configuration message and the one or more configuration parameter sets, at least one CSI report indicating a first CSI report quantity including a first value for a first set of slots associated with SBFD symbols and a second value for a second set of slots associated with non-SBFD symbols corresponding to DL transmission. The operations of 2304 may be performed in accordance with examples as described herein. In some implementations, aspects of the operations of 2304 may be performed by a NE as described with reference to FIG. 21.

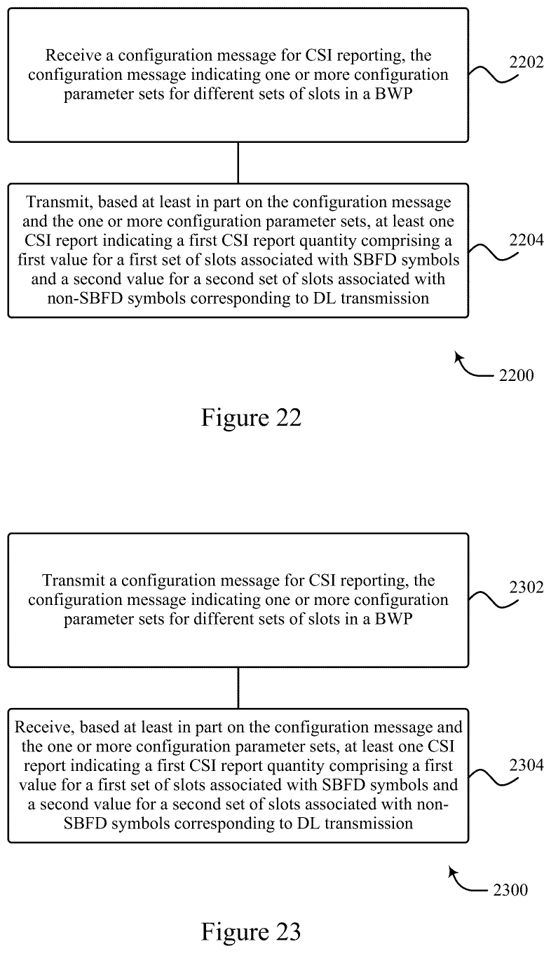

FIG. 24 illustrates a flowchart of a method 2400 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2402, the method may include receiving a configuration message for CSI-RS resource settings, the configuration message indicating one or more CSI-RS resources, where at least one CSI-RS resource is associated with two different time resource types. The operations of 2402 may be performed in accordance with examples as described herein. In some implementations, aspects of the operations of 2402 may be performed by a UE as described with reference to FIG. 19.

At 2404, the method may include transmitting, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type. The operations of 2404 may be performed in accordance with examples as described herein. In some implementations, aspects of the operations of 2404 may be performed by a UE as described with reference to FIG. 19.

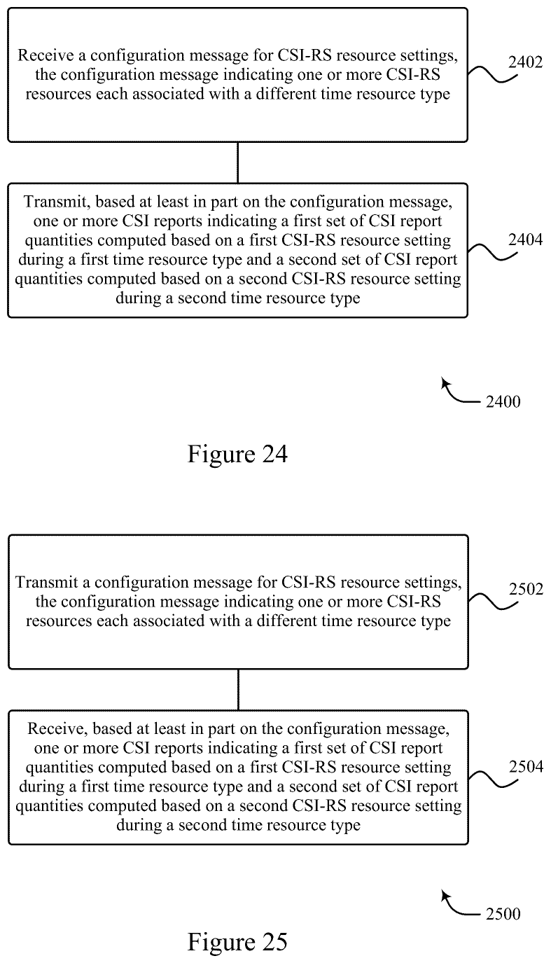

FIG. 25 illustrates a flowchart of a method 2500 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2502, the method may include transmitting a configuration message for CSI reporting, the configuration message indicating one or more configuration parameter sets for different sets of slots in a BWP. The operations of 2502 may be performed in accordance with examples as described herein. In some implementations, aspects of the operations of 2502 may be performed by a NE as described with reference to FIG. 21.

At 2504, the method may include receiving, based at least in part on the configuration message, one or more CSI reports indicating a first set of CSI report quantities computed based on a first CSI-RS resource setting during a first time resource type and a second set of CSI report quantities computed based on a second CSI-RS resource setting during a second time resource type. The operations of 2504 may be performed in accordance with examples as described herein. In some implementations, aspects of the operations of 2504 may be performed by a NE as described with reference to FIG. 21.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration message for channel state information (CSI) reporting, the configuration message indicating one or more configuration parameter sets for different sets of slots in a bandwidth part (BWP); and
transmit, based at least in part on the configuration message and the one or more configuration parameter sets, at least one CSI report indicating a first CSI report quantity comprising a first value for a first set of slots associated with sub-band full duplex (SBFD) symbols and a second value for a second set of slots associated with non-SBFD symbols corresponding to downlink (DL) transmission.

2. The UE of claim 1, wherein the first set of slots includes at least one sub-band group associated with uplink (UL) transmission and at least one other sub-band group associated with DL transmission.

3. The UE of claim 2, wherein the at least one CSI report indicates a second CSI report quantity comprising a first value for the at least one sub-band group and a second value for the at least one other sub-band group.

4. The UE of claim 3, wherein the second CSI report quantity corresponds to a channel quality indicator (CQI), the at least one CSI report indicating a first CQI value associated with the at least one sub-band group and a second CQI value associated with the at least one other sub-band group.

5. The UE of claim 3, wherein the second CSI report quantity corresponds to a precoding matrix indicator (PMI), the at least one CSI report indicating a first PMI value associated with the at least one sub-band group and a second PMI value associated with the at least one other sub-band group.

6. The UE of claim 5, wherein the SBFD symbols are associated with three sub-band groups corresponding to two non-contiguous DL sub-bands and one UL sub-band, the at least one CSI report indicating a distinct PMI value for each of the three sub-band groups.

7. The UE of claim 2, wherein the configuration message includes two CSI reporting sub-configurations corresponding to two of: the SBFD symbols, the non-SBFD symbols, the at least one sub-band group, or the at least one other sub-band group.

8. The UE of claim 7, wherein each of the CSI reporting sub-configurations is associated with at least one of a CSI sub-report or a CSI report.

9. The UE of claim 1, wherein the first CSI report quantity corresponds to a channel quality indicator (CQI), the at least one CSI report indicating a first CQI value for the first set of slots and a second CQI value for the second set of slots.

10. The UE of claim 1, wherein the SBFD symbols are associated with two sub-band groups corresponding to one downlink (DL) sub-band and one uplink (UL) sub-band, the at least one CSI report indicating a distinct precoding matrix indicator (PMI) value for each of the two sub-band groups.

11. The UE of claim 10, wherein the at least one CSI report indicates a common channel quality indicator (CQI) value for the SBFD symbols and the non-SBFD symbols.

12. The UE of claim 1, wherein the at least one CSI report indicates a common precoding matrix indicator (PMI) value for the SBFD symbols and the non-SBFD symbols.

13. The UE of claim 1, wherein the at least one CSI report indicates a common rank indicator (RI) value for the SBFD symbols and the non-SBFD symbols.

14. The UE of claim 1, wherein the at least one CSI report includes a first part and a second part, each part associated with one or more CSI parameters, and the second part including one or more groups.

15. The UE of claim 14, wherein a first group of the one or more groups includes a first set of precoding matrix indicator (PMI) parameters associated with the SBFD symbols, and a second group of the one or more groups includes a second set of PMI parameters associated with the non-SBFD symbols.

16. The UE of claim 1, wherein the configuration message includes an identification of a configuration message associated with an SBFD symbols-related configuration.

17. A processor for wireless communication, comprising:
at least one controller coupled with at least one memory and configured to cause the processor to:
receive a configuration message for channel state information (CSI) reporting, the configuration message indicating one or more configuration parameter sets for different sets of slots in a bandwidth part (BWP); and
transmit, based at least in part on the configuration message and the one or more configuration parameter sets, at least one CSI report indicating a first CSI report quantity comprising a first value for a first set of slots associated with sub-band full duplex (SBFD) symbols and a second value for a second set of slots associated with non-SBFD symbols corresponding to downlink (DL) transmission.

18. The processor of claim 17, wherein the first set of slots includes at least one sub-band group associated with uplink (UL) transmission and at least one other sub-band group associated with DL transmission.

19. A method performed by a user equipment (UE), the method comprising:
receiving a configuration message for channel state information (CSI) reporting, the configuration message indicating one or more configuration parameter sets for different sets of slots in a bandwidth part (BWP); and
transmitting, based at least in part on the configuration message and the one or more configuration parameter sets, at least one CSI report indicating a first CSI report quantity comprising a first value for a first set of slots associated with sub-band full duplex (SBFD) symbols and a second value for a second set of slots associated with non-SBFD symbols corresponding to downlink (DL) transmission.

20. A network equipment (NE) for wireless communication, comprising:
at least one memory; and
at least one processor coupled with the at least one memory and configured to cause the NE to:
transmit a configuration message for channel state information (CSI) reporting, the configuration message indicating one or more configuration parameter sets for different sets of slots in a bandwidth part (BWP); and
receive, based at least in part on the configuration message and the one or more configuration parameter sets, at least one CSI report indicating a first CSI report quantity comprising a first value for a first set of slots associated with sub-band full duplex (SBFD) symbols and a second value for a second set of slots associated with non-SBFD symbols corresponding to downlink (DL) transmission.
